(19) United States
(12) Patent Application Publication
(10) Pub. No.: US 2017/0195795 A1
(43) Pub. Date: Jul. 6, 2017

(54) INTELLIGENT 3D EARPHONE

(71) Applicant: Cyber Group USA Inc., Forest Hills, NY (US)

(72) Inventors: David MEI, Forest Hills, NY (US); Jin Xia BAO, Forest Hills, NY (US)

(73) Assignee: Cyber Group USA Inc., Forest Hills, NY (US)

(21) Appl. No.: 15/359,790

(22) Filed: Nov. 23, 2016

Related U.S. Application Data
(60) Provisional application No. 62/387,657, filed on Dec. 30, 2015.

(51) Int. Cl. H04R 5/033; H04R 5/04; H04R 1/10; G06F 3/0481; G06F 3/0482; H04S 7/00; G06F 3/16

(52) U.S. Cl. CPC H04R 5/0335; H04S 7/304; H04R 5/04; G06F 3/165; G06F 3/04817; G06F 3/0482; H04R 1/1008; H04R 1/1016; H04S 2400/11

(57) ABSTRACT

An earphone produces an intelligently-changing stereo sound effect. The earphone includes an ear cup, at least one speaker disposed in the ear cup, a processing unit disposed in or attached to the ear cup and connected to the speaker, and at least one sensor disposed in or attached to the ear cup and connected to the processing unit. The sensor is configured to sense a movement of the earphone or an environmental change of the earphone and to send the processing unit a signal representing the movement or the environmental change. The processing unit is programmed to process the signal and to generate a changed stereo signal for the speaker. The changed stereo signal is changed according to the movement or the environmental change. The speaker is configured to receive the changed stereo signal and to generate a changed stereo sound effect according to the changed stereo signal.

### CROSS REFERENCE TO RELATED APPLICATIONS

Applicant claims priority under 35 U.S.C. 119(e) to U.S. Provisional Patent Application No. 62/387,657 filed Dec. 30, 2015, the disclosure of which is incorporated by reference.

### BACKGROUND OF THE INVENTION

1. Field of the Invention

The present invention is an improvement on U.S. Pat. No. 7,697,709 and No. 8,515,103 arid relates to an earphone for use with audio systems and communication systems and more particularly to an earphone or headset for providing 3D stereo earphone with intelligent functions and systems and methods to achieve intelligent 3D real stereo sound, 3D virtual Reality (VR) sound, 3D Augmental Reality (AR) sound, 3D Mix Reality (MR) sound, 3D Holography sound, and combinations of any kind of real and VR/AR/MR/Holography 3D video and 3D audio.

2. The Prior Art.

There are more earphones and headphones coming into the market with smart or intelligent functions. U.S. Pat. No. 8,306,235 to Apple Inc. uses a sound sensor to adjust the audio output of a device. The sensor is for the environment sound level control of that device, but is not for a user's movements and needs of using that device and is not for a user's environment and requirements of how to use that device with the sound sensors.

As prior art, there are many types of earphones and headphones having multiple sensors in the market already. How to use sensors for earphones and headphones is another new technology area for smart or intelligent earphones and headphones. For example, U.S. Pat. No. 8,320,578 is related to this technology. That patent exposes how to use an orientation sensor, a temperature sensor, and a heart rate sensor to configure the headset based on the position of the headset on the user's head. But those sensors and all of their related functions are not to improve the sound effects and outputs of that headset.

Jabra's Intelligent Headset is also to use multiple inside sensors for its True3Daudio to sense a user's location and head movement and where and what direction he or she is facing by operating interactive mobile apps only. It is only the apps that control and operate those sensors and their functions for the Intelligent Headset through wireless or cable communication in one way or one direction only. There is no control or operation function or system or structure or method an the Intelligent Headset that creates new 3D stereo sound effects and outputs by following a user's movement and needs. Obviously, it is not convenient if a user can't control or operate those intelligent functions from his headset directly, and can't have those functions by controlling and operating his headset, with the apps together in one way, two ways, or multiple ways, and in one direction, two directions, or multiple directions, at the same time and same place.

U.S. Pat. No. 9,167,242 explores a measurement method of the sensors adapted to work from the video or audio inputs to outputs. But this method is not related to a user's environments, movements, and needs.

Many new developments are to use module methods to carry out automated technology for an earphone or a headphone. For example, U.S. Pat. No. 9,397,178 develops a headphone with active noise cancelling and auto-calibration method. They use a noise cancelling module to facilitate auto-calibration of sound signals. Those auto-calibration methods are limited to the audio signal noise cancelling only.

Intelligent Wearable new technology is a new development area, especially in VR/AR/MR technologies. U.S. Pat. No. 9,204,214 exposes a new method of wearable sound processing and voice operated control for an earpiece. But this new development is not for a wearer's movements and needs of working for 3D sound effects and outputs.

Therefore, in order to solve the foregoing problems and drawbacks, a need exists for an earphone or headphone with intelligent functions and systems and methods to achieve intelligent 3D real stereo sound, 3D Virtual Reality (VR) sound, 3D Augmental Reality (AR) sound, 3D Mix Reality (MR) sound, 3D Holography sound, and combinations of any kind of real and VR/AR/MR/Holography 3D video and 3D audio.

### SUMMARY OF THE INVENTION

The present invention provides an earphone or a headset with intelligent units, multiple sensor units, and multiple speakers and a sound effect unit and sound resonance unit to achieve intelligent 3D stereo sound effects and outputs by following or reflecting a user's movements, environments, and needs, automatically, intelligently, at the same time and same pace and same vision and sound space.

In one aspect, an intelligent unit having multiple motion sensor and processor units is disposed inside the ear cup unit of the earphone. The intelligent unit and motion sensor and processor units detect a user's body movements and a user's needs to generate automatically a set of self-configured new 3D stereo sound effects and outputs accordingly.

Also, the intelligent unit and multi sensor units detect a user's environment or surrounding to carry out VR/AR/MR visual and audio configuration intelligent new 3D stereo sound effects and outputs.

The earphone produces an intelligently-changing stereo sound effect. The earphone includes (a) an ear cup, (b) at least one speaker disposed in the ear cup, (c) a processing unit disposed in or attached to the ear cup and connected to the at least one speaker, and (d) at least one sensor disposed in or attached to the ear cup and connected to the processing unit. The at least one sensor is configured to sense a movement of the earphone or an environmental change of the earphone and to send the processing unit a signal representing the movement or the environmental change. The processing unit is programmed to process the signal and to generate a changed stereo signal for the at least one speaker. The changed stereo signal is changed according to the movement or the environmental change. The at least one speaker is configured to receive the changed stereo signal and to generate a changed stereo sound effect according to the changed stereo signal.

The intelligent unit and computerized motion sensors detect and process the motion and environment movements and control the 3D sound frequency configuration system of multiple speakers with a sound effect unit and sound resonance unit for new 3D stereo sound, effects and outputs.

There are many ways to achieve new 3D stereo sound effects and outputs of the intelligent 3D earphone by carrying out the intelligent functions, systems, methods, and structures to follow or reflect a user's needs, movements, environments, and situations.

The intelligent unit automatically detects, analyzes, records, processes, and directs the result and self configuration of a user's activities, situations, and needs to generate new 3D stereo high sound frequency into one speaker, to generate new 3D middle sound frequency into another speaker, and to generate new 3D bass sound frequency into a third speaker, working with the sound effect unit and sound resonance unit together in order to achieve intelligent new 3D stereo sound effects and outputs for a very strong and powerful bass and resonance/harmony performance stereo in three dimensional (3D) sound effects and outputs under the multiple speakers arrayed in multiple ways.

The shape of the ear cup of the intelligent 3D earphone is directly related to the intelligent unit and sensor units, the speakers, the sound effect unit and sound resonance unit, outside the ear cup and/or inside the ear cup.

The intelligent 3D earphone is to work wirelessly or with a cable connection, with modules inside and outside, and with any kind of shape and design and structure and system and method, such as In-Ear, On-Ear, or Over-Ear, a headband, a helmet, vision glasses, a vision headset, wearable equipment, a robot, 3D holography, etc.

A mother board may be inside the intelligent 3D earphone, in this aspect, there may also be a CPU unit, a memory unit, a battery unit, a SIM unit, a battery unit, a wireless or cable unit, a rechargeable unit, a microphone unit, a switch unit, a voice control and recognition or ID unit, an amplifier unit, a purifier unit, a communication unit, and a display unit, etc. Additionally, there may be a Multiple Player Unit inside or outside the intelligent 3D earphone.

The intelligent 3D earphone works mutually with an earphone player such as a cellular phone, a multiple player, a smart phone, an electronic portable device, laptops, notebooks, a PC, an app, a VR/AR/MR device, etc., simultaneously and synchronously.

The intelligent 3D earphone works mutually with a virtual reality vision device or player such as Google Glass and VR Helmet, a robot, a portable and wearable device, etc. simultaneously and synchronously.

The intelligent 3D earphone and earphone player and vision device or player can work together mutually, in one way, two ways, multiple ways, at the same time and same pace and same visual and audio space, simultaneously and synchronously.

The intelligent 3D earphone works with or for artificial intelligence functions such as 3D stereo sound effects and outputs for robot intelligence, internet intelligence, wearable intelligence, etc.

The intelligent 3D earphone contains speaker cup units, multiple speakers/units, sound controllers, a sound effect unit, sound resonators, speaker output units, and a sound output or direction-adjustable sound output unit for 3D stereo sound effects and outputs.

The intelligent 3D earphone may have an ear holder unit with a joint unit (male or female part) adjustable in three dimensions (X, Y, & Z) attached to work adjustably with another joint unit (male or female part). The joint units may be designed to be attachable and detachable as a big C structure, or a clip structure, or a plug in-and-out structure, or a ball structure, or a stick structure, or a bar structure, or any kind at attachable and detachable fastener structure.

In short, the present invention provides a system that achieves new X-Y-Z 3D stereo sound effects and outputs with the intelligent functions by following or reflecting a user's movements, environments, situations, and needs.

An object of the present invention is to provide an earphone to achieve new X-Y-Z 3D stereo sound effects and outputs with intelligent functions by following and reflecting a user's movements, environments, situations, and needs.

Yet another object of the present invention is to provide an earphone to work mutually in one way or two ways or multiple ways with or fox the earphone players such as cell phones and multiple players and apps, to achieve new 3D stereo sound effects and outputs with intelligent functions by following and reflecting a user's movements, environments, situations, and needs, simultaneously and synchronously.

Another object of the present invention is to provide an earphone to work, mutually in one way or two ways or multiple ways with or for VR/AR/MR vision devices and AI wearable devices to achieve new 3D stereo sound effects and outputs with intelligent functions by following and reflecting a user's movements, environments, situations, and needs, simultaneously and synchronously.

Yet another object of the present invention is that the intelligent 3D earphone and the earphone player and vision device or player work together mutually in one way or two ways or multiple ways to achieve new 3D stereo sound effects and outputs with intelligent functions by following and reflecting a user's movements, environments, situations, and needs, simultaneously and synchronously.

Another object of the present invention is to provide an earphone with an intelligent unit, sensor units, and multiple speakers, and to work with sound waves a sound effect unit, a sound resonator (resonance unit), a sound controller, a sound balance hole unit, and a sound output unit for X-Y-Z 3D stereo sound effects and outputs simultaneously and synchronously.

Yet another object of the present invention is to provide an earphone with an intelligent unit and sensor units located inside the earphone or outside the earphone to achieve new 3D stereo sound effects and outputs.

Another object of the present invention is to provide art earphone with an intelligent unit and sensor units containing attachable and detachable and modular assembly functions and structures and a display unit as a mini remote or mobile controller, or a mobile communication and play tool, or a mobile operation center, to achieve new 3D stereo sound effects and outputs.

Yet another object of the present invention is to provide an earphone with an attachable and detachable intelligent unit and attachable and detachable sensor units and a display unit to achieve a wearable function and structure that can operate wirelessly or with a cable connection for sports, health, training, entertainment, work, studies, medical needs, for a robot, artificial intelligent (AI) wear, an AI tool, AI equipment, 3D Holography, etc., with new 3D stereo sound effects and outputs.

Another object of the present invention is to enable a user to hear new 3D stereo sound effects and outputs to follow or reflect his or her movements, environments, situations, and desires, especially for VR/AR/MR visual and stereo sound combinations and effects and outputs.

Yet another object of the present invention is to provide an earphone with the capability of detecting and analyzing a user's body movement, a user's mind movement, and a user's eye movement to achieve new 3D stereo sound effects and outputs to follow or reflect those movements for a user's need, especially for a user's needs or desires in artificial intelligences (AI).

Another object of the present invention is that the intelligent 3D earphone and the earphone player and vision device or player work together wirelessly and mutually in one way or two ways or multiple ways to achieve new 3D stereo sound effects and outputs with intelligent functions by following and reflecting a user's movements, environments, situations, and needs, simultaneously and synchronously.

Yet another object of the present invention is to provide an earphone having intelligent functions and multiple speakers and having an attachable or detachable joint structure and function for the ear cup to work with an ear band unit, and ear cap holding unit for wearing comfort and hearing safety with 3D stereo sound effects and direction-adjustable 3D-sound at the same time. The ear band may have adjustable and attachable and detachable joint parts.

### BRIEF DESCRIPTION OF THE DRAWINGS

Other objects and features of the present invention will become apparent from the following detailed description considered in connection with the accompanying drawings. It should be understood, however, that the drawings are designed for the purpose of illustration only and not as a definition of the limits of the invention.

In the drawings, similar reference characters denote similar elements throughout the several views.

FIG. 1 is a side view of an earphone in accordance with a first embodiment of the invention.

FIG. 1A is a side view of another earphone design in accordance with the invention.

FIG. 1B is a side view of one earphone in accordance with the invention.

FIG. 1C is a side view of another earphone in accordance with the invention.

FIG. 2 is a perspective view of another embodiment of one earphone in accordance with the invention with a rear view of a portion of the earphone.

FIG. 2A is a perspective view of another embodiment of one earphone in accordance with the invention with a rear view of a portion of the earphone.

FIG. 2AA is a front view of another embodiment in accordance with the invention.

FIG. 2B is a front view of another embodiment in accordance with the invention.

FIG. 3 is a chart of sound stereo wave/level frequency wave lines in accordance with the invention.

FIG. 3A is a chart of 3D stereo sound changes with a user's movement in accordance with the invention.

FIG. 3B is a chart of 3D stereo sound changes with an outside (environment) sound source/direction movement in accordance with the invention.

FIG. 4 is a chart of sound stereo wave/level frequency wave lines in accordance with the invention.

FIG. 4A is a chart of sound stereo wave/level frequency wave line changes in accordance with the invention.

FIG. 4B is a chart of sound stereo wave/level frequency wave line changes in accordance with the invention.

FIG. 5 is a front view of a graphic drawing in accordance with the invention.

FIG. 5A is an enlarged perspective view of a portion of the embodiment shown as FIG. 5.

FIG. 5AA is a front view of another embodiment in accordance with the invention.

FIG. 6 is a side view of another embodiment of one earphone in accordance with the invention.

FIG. 6A is a side view of one embodiment of one earphone in accordance with the invention.

FIG. 6B is a side view of another embodiment of one earphone in accordance with the invention.

FIG. 6C is a side view and perspective view of one earphone in accordance with the invention.

FIG. 7 is a side view and perspective view of another earphone with wireless or cable and earband functions in accordance with the invention.

### DETAILED DESCRIPTION OF THE PREFERRED EMBODIMENTS

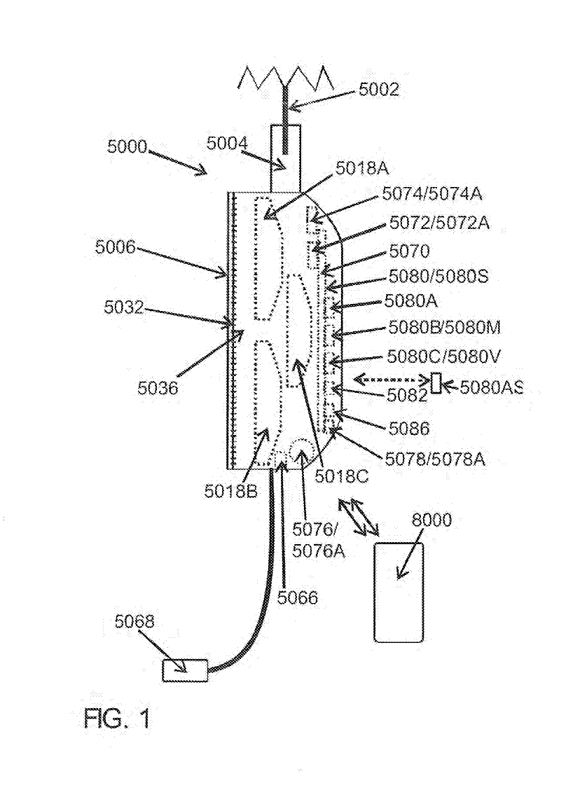

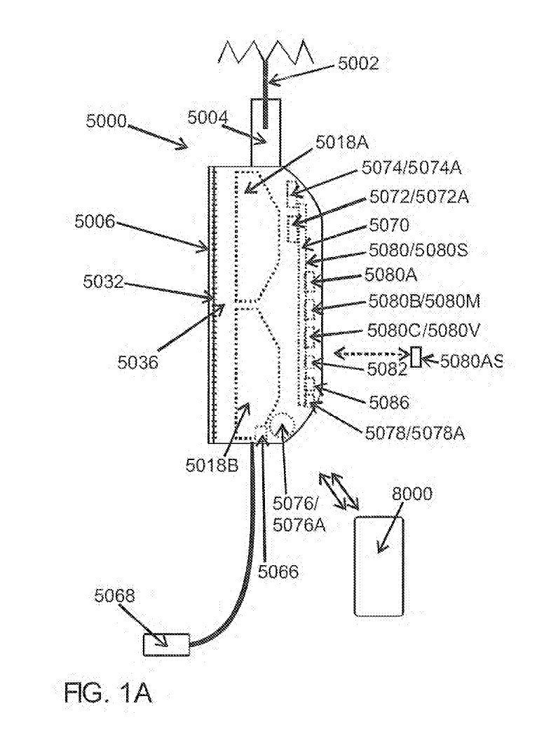

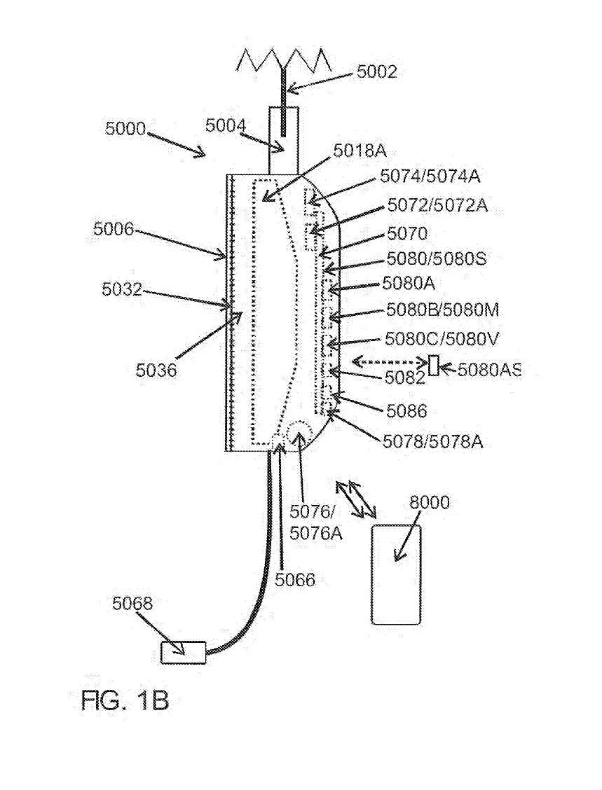

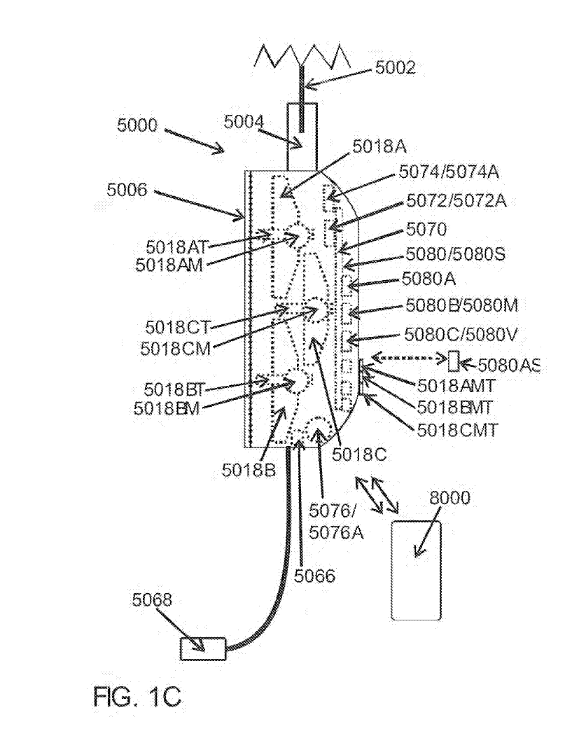

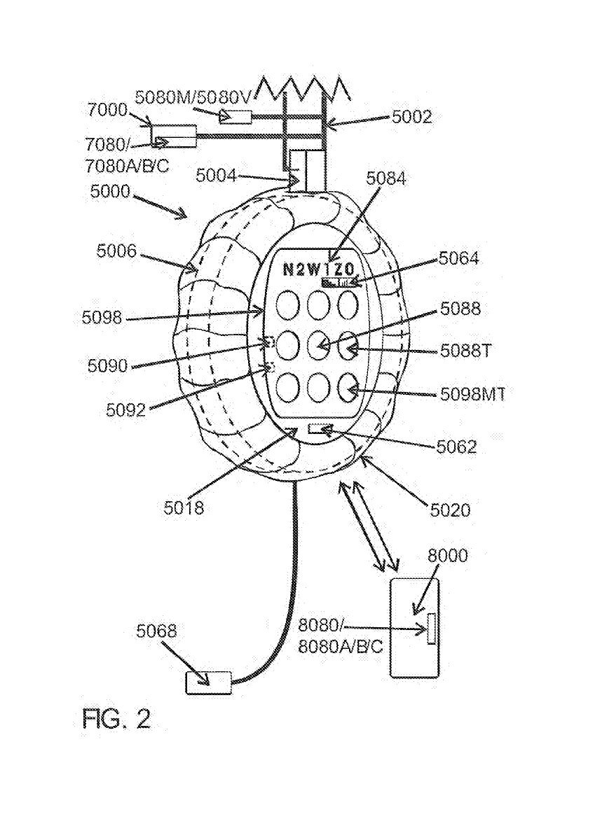

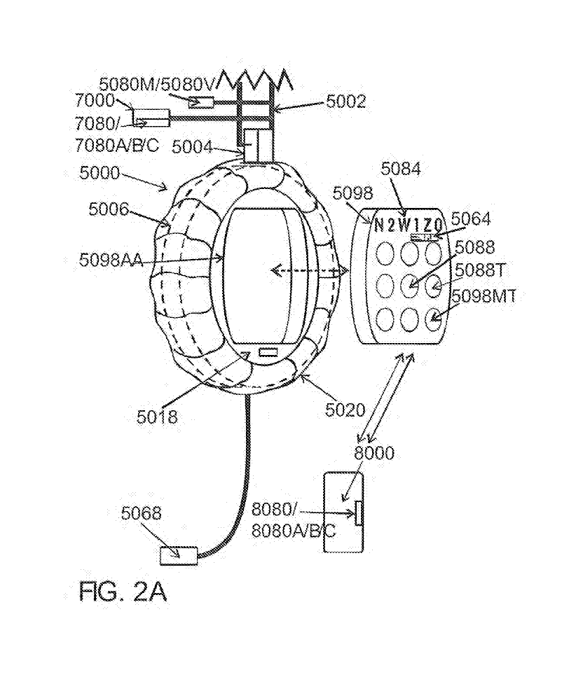

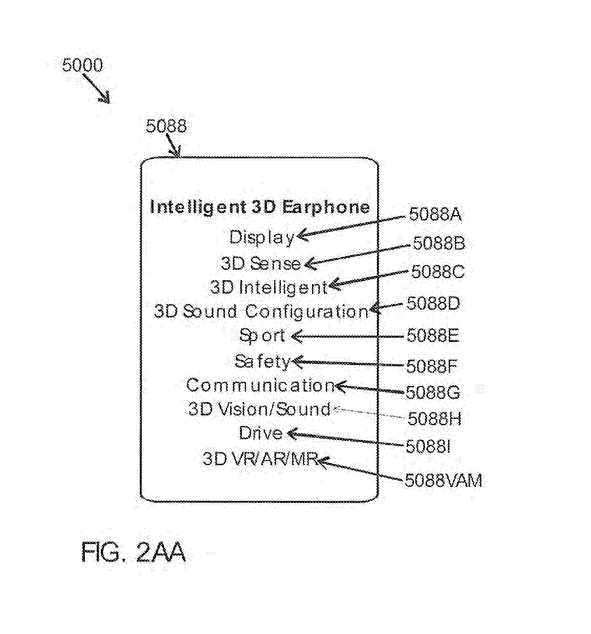

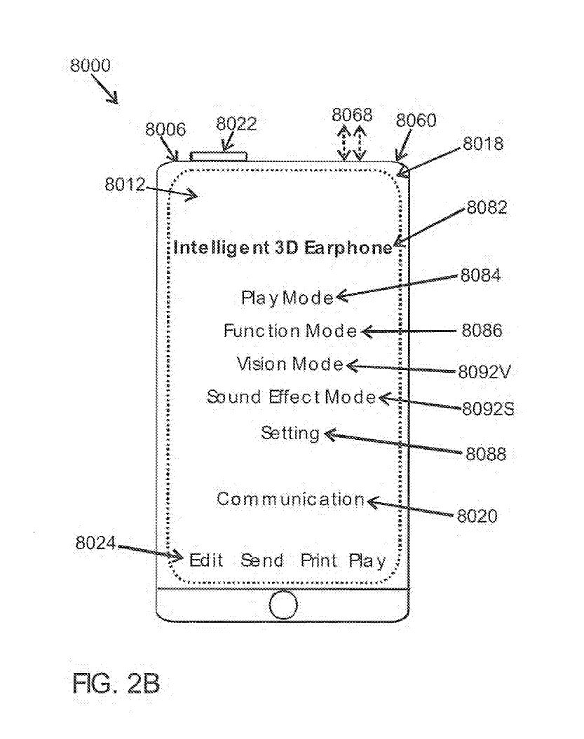

FIGS.1, 1A, 1B, 1C, 2, 2A, and 2AA show an earphone 5000 which may be the left or the right portion of the earphone or headset for providing 3D stereo earphone with intelligent functions and systems and methods to achieve X-Y-Z 3D real stereo sound, 3D Virtual Reality (VR) sound, 3D Augmental Reality (AR) sound, 3D Mix Reality (MR) sound, 3D Artificial Intelligent sound, and combinations of any kind of real and VR and AR and MR and AI video and audio by following or reflecting a user's movements and environments and situations and needs automatically and intelligently at the same time and same pace and same vision and sound space.

Those drawings show that the earphone 5060 may include an Intelligent unit 5080 containing a set of motion and environment sensor and processor and coordination units 5080A, 5080B, 5080C, a mother board 5070 with several micro chips, a CPU and multichip package (MCP) unit 5072, a memory unit 5074, a SIM card unit 5074A for adding memory units or for inserting additional functional units, a battery unit 5076, a recharge unit 5076A, a wireless/cable unit 507B, a microphone unit 5068, a switch unit 5062, a light indicator unit 5064, a voice control and voice recognition/ID unit 5066, an integrated micro sound amplifier unit 5082, a sound purifier unit 5086, a capacitor unit 5090, an internet protocol (IP) based communicator unit 5092, and a multiple player display unit 5098 inside. At the same time, the computerized intelligent sound controller unit 5080 which can also be an intelligent wave/level/frequency reaction and controller and coordination unit is inside the ear speaker cup unit 5006 containing the multiple speaker units 5018A, 5018B, and 5018C working with the sound effect structure unit 5032 and sound resonance area or space or unit 5036 together to create intelligent 3D stereo sound effects and outputs, or smart 3D real stereo sound in 3D stereo sound space or VR/AR/MR/AI vision and sound space.

The intelligent unit 5080 contains motion sensor and processor units 5080A, 5080B, and 5080C to detect a user's body movements and a user's needs for VR/AR/MR/AI to generate automatically a set of self-configured new 3D stereo sound effects and outputs accordingly. Also, the intelligent unit 5080 contains motion sensor and processor units 5080A, 5080B, and 5080C to detect a user's environment or surrounding or to carry out VR/AR/MR visual and audio combinations to generate automatically a set of self-configured intelligent new 3D stereo sound effects and outputs. The intelligent unit 5080 and the computerized motion sensor units 5080A/B/C detect and process and control the motion or environment movements and 3D sound frequency configuration system of multiple speaker units that includes 3D stereo sound speaker units 5018A, 5018B, and 5018C.

The intelligent unit 5080 automatically detects, analyzes, records, processes, and directs the result and self auto-configuration of those activities or situations to generate 3D stereo high sound frequency into the first speaker units 5018A/B and generate the bass/middle frequencies of 3D stereo sounds into the speaker unit 5018C, working with the sound effect structure unit 5032 and sound resonance unit 5036 together in order to achieve intelligent 3D stereo sound effects for a very strong and powerful bass and resonance/harmony performance stereo in X-Y-Z three dimensional (3D) sound effects under the multiple drivers arrayed in multiple ways.

The ear cup 5006 and speaker units 5018A/B/C and sound effect unit 5032 and sound resonance/harmony unit 5036 all work together to generate 3D stereo sound effects and outputs, with all their functions, structures, systems, methods, materials, designs, and formats as detailed in U.S. Pat. No. 7,697,709 and No. 8,515,103.

The intelligent unit 5080 and sensor units 5080A/B/C can be in one unit, or two units, or multiple units, together or separate or independent.

Any sensor unit 5080A to C can be independent or separate from the intelligent unit 5080 if needed.

The design, function, method, structure, material, shape, size, type, and location of the intelligent unit 5080 and its sensor units 5080A/B/C with mini or micro circuit board and micro chips inside may vary if needed.

The wireless/cable unit 5078 may deliver to or receive (receiver/sender unit 5078A) from a circumaural wireless stereo radio frequency (RF) system, or an internet server system, or blue tooth, or Wi-Fi system, or home and work connections, app, cloud system, etc.

The CPU/MCP unit 5072 may contain a digital signal processor 5072A providing full range digital audio output of earphone 5000.

Therefore, the Intelligent 3D stereo earphone 5000 may be used wirelessly or through a cable in a regular earphone system, a regular headset/headphone system, a cell phone, a smart phone, a multiple player, a radio system, a telephone system, a personal computer (PC) system, a notebook computer, an internet communication system, a cellular/satellite communication system, a GPS system, a home theater system, a car/ship/airplane audio system, a game, a VR/AR/MR device, an app, ear hearing assistance equipment, or medical equipment, etc.

The intelligent 3D stereo earphone 5000 can be structured or designed with all unite or several units in module combinations or a module assembly, an outside insert or in/out plug, attachable or detachable, or with inside connections, or interchangeable at same time. For example, additional sensor units 5080AS can be plugged in or out as module assemblies. All units in FIGS 1-2AA and 5-7 can do that too.

The Intelligent 3D stereo earphone 5000 can be with any kind of design, format, structure, system, function, etc., such as a head band, a helmet, a neck band, a wearable set, etc., to work with VR/AR/MR visual and audio with related or coordinated 3D stereo sound effects and outputs.

The Intelligent 3D stereo earphone 5000 can be used or can work with any kind of VR/AR/MR or any kind of artificial intelligence (AI) or any kind of robot system.

The intelligent, unit 5080 and motion sensors 5090A/B/C are to sense or detect a user's body movements and related surroundings and carry out VR/AR/MR commands and needs. According to a pre-selected mode selected by the user, the intelligent unit 5080 receives and analyzes those sensed movements or VR/AR/MR commands to generate automatically new 3D stereo sound effects and outputs. Thus, a user can hear a new 3D stereo sound to follow and reflect his or her movements and his or her desires for VR/AR/MR/AI visual and stereo sound combinations and effects and outputs.

Traditionally, an earphone is only to deliver or play sound or audio recorded in certain electronic formats, such as a format from a CD, an electronic file, a hard drive, the internet, etc. A user is not able to change or update these kinds of sound outputs or sound effects when using a traditional earphone. A user's needs or body movements or environments, or surroundings, or situations, are not related absolutely to any sound output or effect playing in a traditional earphone, in other words, a traditional earphone is only s negative electronic player, is not intelligent, and has nothing to do with and does not react to a user's movements or situations or special needs for VR/AR/MR/AI. There is not any connection between the traditional earphone and its user's movements and surrounding situations and intelligent needs.

The intelligent unit 5080 and its sensors 5080A/B/C are intelligently and positively to connect or follow a user's movements and surrounding situations and VR/AR/MR/AI needs with the earphone sound system automatically at the same time, same pace, and same space, through a self motivated configuration system generated by the CPU unit 5072, the memory unit 5074, the sound amplifier unit 5082, and all other related units inside the intelligent unit 5080 to create a new 3D stereo sound effects and outputs following and reflecting a user's movements and needs. In that case, the intelligent 3D earphone 5000 is to become a user's electronic ears to react and hear real world 3D stereo sound effects or artificial intelligent 3D stereo sound effects or combinations of both.

A user's movements can be body movements, mind movements, visual movements, or sound movements run separately or combined together in multiple ways. The user's mind movements or visual movements can be sensed by the brain sensor unit 5080M or visual sensor unit 5080V with any electronic sensor devices to obtain the user's mind or visual electronic or nervous flows for mind work or vision work or health work. For example, the electronic sensor devices can be electroencephalogram devices for brain cell or nervous electronic movements, can perform electrocardiogram for heart beats, can be a blood pressure machine or temperature instruments, can perform visual or eye or eyeball or iris or pupil tracking, or can be sound or mouth tracking systems for VR/AR/MR/AI effects and outputs, etc.

A user's surrounding environment or situation can be any kind of real world surrounding condition or situation around the user. The intelligent unit 5080 can sense a user's surrounding situation, such as light level, temperature, rain, wind, sky, sun, moon, stars, fog, physical things, human beings, animals, etc.

Thus, the intelligent 3D earphone 5000 can sense environment signals for the user. For example, the intelligent unit 5080 can sense a stranger approaching and then immediately send a warning signal to the earphone speakers 5018A/B/C for the user's safety check. The intelligent unit 5080 can sense a car trailing too closely and then immediately send a traffic warning signal to the earphone speakers 5018A/B/C for the user's traffic safety alarm.

It is very important to have the safety alarm function for the user's situation, because all current earphones are with “isolated function” for pure sound effects and outputs. Earphone noise isolation becomes a basic function for all earphones currently on the market. A user wearing an “isolated” earphone has difficulty hearing outside sound, such as a traffic warning sound, etc. The intelligent 3D earphone 5000 can overcome that problem with its intelligent unit 5080 and its sensor/processor units 5080A/B/C to detect process, analyze, and configure new 3D stereo sound effects and outputs with a safety warning function with respect to a user's surrounding, such as detecting and warning a traffic red light, or sensing and warning an approaching car, etc.

At the same time, if needed, the intelligent unit 5080 can have a self auto-adjustable function according to a user's surrounding situation. Fox example, if the intelligent unit 5080 and its sensor units 5080A/B/C sense too high amounts of noise in the environment, they immediately self-adjust the sound output volume level upwards based on the noise control mode preset or preselected. If the intelligent unit 5080 senses the environment becoming quiet, the intelligent unit 5080 will auto-adjust back to the original sound output volume.

The intelligent unit 5080 can sense and control and auto-adjust all noises from outside the earphone 5000 and all noises Exam inside the earphone 5000 such as electrical flow noise, etc., based on a user's needs, at the same time.

Also at the same time, the intelligent unit 5080 can have a coordination system. 5080S Lo work with VR/AR/MR visual and audio effects and outputs accordingly.

Furthermore, the intelligent 3D earphone 5000 and intelligent unit 5080 and its sensors 5080A/B/C can work with any kind of earphone player 8000. For example, the earphone player 8000 can be any kind of electronic device, such as a cellular phone, a multiple player, a portable player, a computer, a notebook, a TV set, the internet, app, electronic portable device, VR/AR/MR device, etc. The intelligent unit 5080 can send or command its electronic signals to any kind of earphone player 8000 by wireless or cable communication. At the same time, any kind of earphone player 8000 can send or command its electronic signals to the intelligent unit 5080 synchronously, by wireless or cable communication.

The earphone player 8000 can be any kind of multiple players, cellular phones, smart phones, electronic portable devices, laptops, notebooks, PC, app, VR/AR/MR/AI devices, etc., in various designs, materials, methods, functions, systems, materials, and formats, etc.

The earphone player 8000 may contain its own intelligent unit 8080 and sensor/processor units 8080A/B/C, very similar to the intelligent 3D earphone's intelligent unit 5080 and sensor/processor units 5080A/B/C. Those 2 sets of the intelligent units of the earphone player 8000 and 3D earphone 5000 work together to create new 3D stereo sound effects and outputs in parallel synchronously, simultaneously and collaterally, in one way, two ways, or multiple ways, with one direction, two directions, or multiple directions if needed.

The earphone player 8000 can send or receive the electronic signals to or from the intelligent 3D earphone 5000 and save those signals into electronic files or data, for replay, editing, saving, or delivery for intelligent 3D stereo sound usages anytime and anywhere by wireless or cable communication.

The intelligent 30 earphone 5000 can send or receive the electronics signals to or from the earphone player 8000 and save those signals into electronic files or data, for replay, editing, saving, or delivery for intelligent 3D stereo sound usages anytime and anywhere by wireless or cable communication.

Therefore, the intelligent 3D earphone 5000 can co-work with any kind of earphone player 8000 together at the same time. The intelligent 3D earphone 5000 and any kind of earphone player 8000 can exchange or co-work or co-do self-configuration of all kind of data or files anytime and anywhere, by wireless or cable line communication.

There can be any kind of design, system, method, structure, and function with the intelligent 3D earphone 5000 and earphone player 8000 or related devices.

The intelligent 3D earphone 5000 and its intelligent unit 5080 have to set up a beginning point first. The beginning point is called a Z point mode. There are an X axis and a Y axis for a traditional sound curve or frequency development. There is a Z axis for 3D stereo sound space development, namely X-Y-Z 3 Dimensional stereo sound space. The Z axis is a key to create X-Y-Z 3 dimensional (3D) stereo sound. Thus, the beginning Z point is a key to create the intelligent 3D stereo sound system.

There are 3 kinds of Z points of the intelligent 3D stereo sound system in the intelligent 3D earphone 5000 and its intelligent unit 5080 and sensor units 5080A/B/C. First, is a user's self-standing point as Z point A. This z-self point mode is to use a user's position and self-movement for creation of the intelligent 3D stereo sound effects and outputs. Second, is a user's environment or surrounding as Z point B. This Z-surrounding point is to use a user's surrounding and related environment for creation of the intelligent 3D stereo sound effects and outputs. Third, is a sound Z axis position and direction as Z point C. This Z-axis sound point is to use 3D stereo sound depth (Z-axis) for creation of the intelligent X-Y-Z 3D stereo sound effects and outputs. Preferably, the Z-axis sound point is for the intelligent unit 5080 to control and manage and configure the speaker 5018C or any bass sound speaker to have the sound depth at Z-axis sound space to achieve the intelligent X-Y-Z 3D stereo sound effects and outputs. Of course, the Z-axis sound point function can be used for any speaker 5018A, 5018B, or 5018C or for other speakers, or for any combination of those speakers 5018A/B/C for the sound depth at Z-axis sound space.

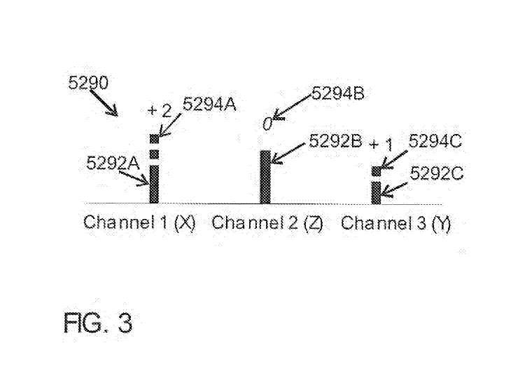

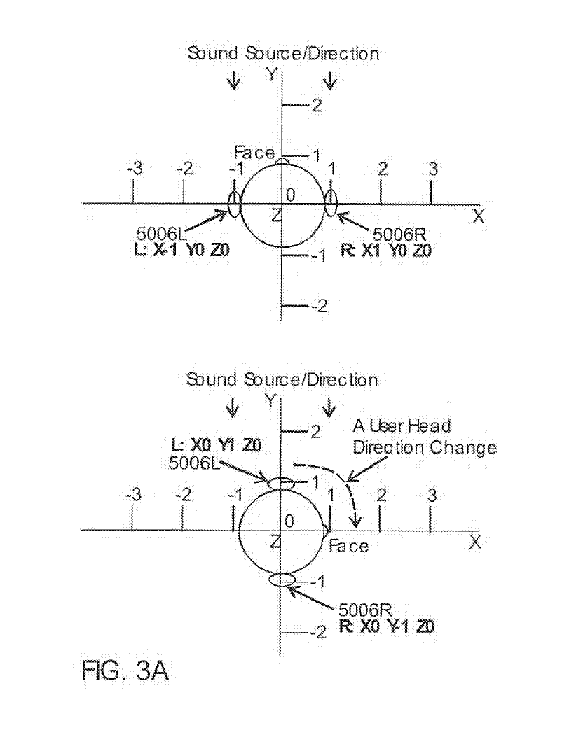

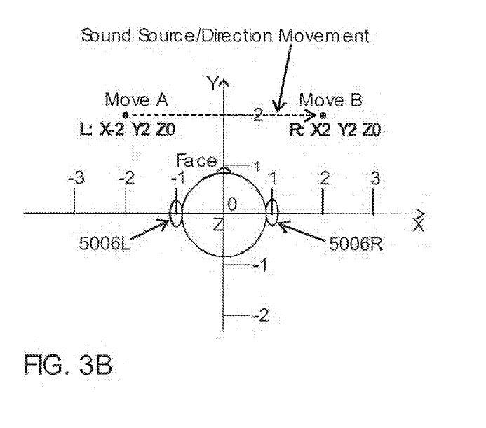

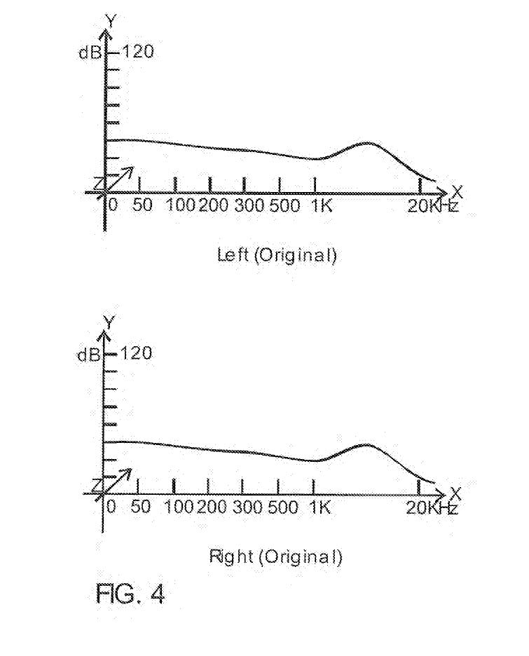

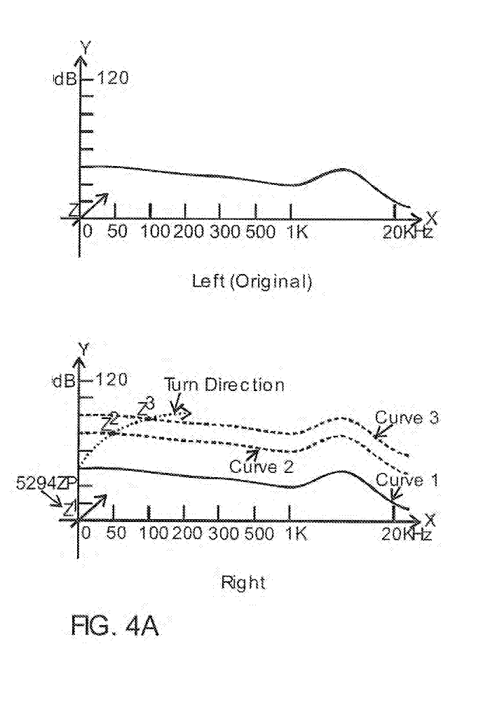

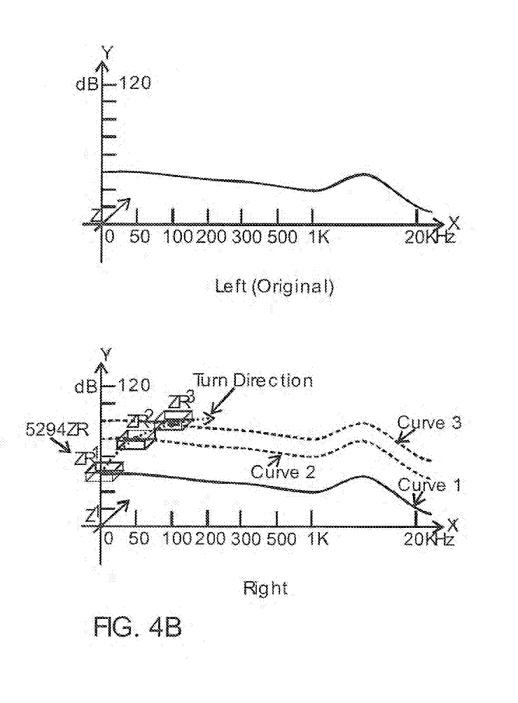

In general, the intelligent 3D stereo sound system containing those Z points A/B/C works with the intelligent unit 5080 together to control and manage and auto configure the intelligent sensor units 5080A/B/C and speakers 5018A/B/C and sound effect unit 5032 and sound resonance unit 5036 to have the sound X-Y axis width and sound Z axis depth at stereo sound space to achieve the intelligent X-Y-Z 3D stereo sound effects and outputs by following and reflecting a user's movements, environments, situations, and needs, synchronously, simultaneously and collaterally, more detailed as illustrated in FIGS 3 to 4B.

There are many types of sensors for the intelligent 3D earphone 5000 and its intelligent unit 5080 and intelligent sensor units 5080A/B/C, such as an accelerometer sensor, a magnetic field sensor, an orientation sensor, a gyroscope sensor, a light sensor, a pressure sensor, a temperature sensor, a proximity sensor, a gravity sensor, a linear acceleration sensor, a rotation sensor, a car sensor, an electrical signal sensor, a wireless signal sensor, a sound sensor, a heart sensor, a blood pressure sensor, a smell sensor, a space sensor, an environment or surrounding sensor a traffic sensor, a warning sensor, a motion sensor, an outside noise sensor, an inside noise sensor, a direction sensor, a navigation sensor, a balance sensor, e distance sensor, a visual/eye tracking or control sensor, a sound/mouth tracking or control sensor, a sensor for an Android system, Apple system, or window system, or other systems, etc., for real world or virtual world 3D stereo sound effects and outputs.

There are many function modes of the intelligent 3D earphone 5000, such as an intelligent 3D stereo sound mode, a mimic mode, a safety mode, a drive mode, an electronic control mode, a voice control mode, a display mode, a sport mode, a work mode, a health mode, an intelligent 3D stereo sound and virtual made, a VR/AR/MR mode, a drive mode, a game mode, etc.

There are many play modes of the intelligent 3D earphone 5000, such as a multiple player mode, a game mode, a sport mode, an education mode, a health mode, a security mode, a home entertainment mode, a VR/AR/MR play mode, etc.

Of course, FIG. 1 also shows that the intelligent 3D earphone 5000 contains the intelligent unit 5080 and multiple speakers 5018A/B/C to deliver intelligent 3D stereo sound effects and outputs.

The Intelligent 3D earphone 5000 and its intelligent unit 5080 detect, analyze, process, and configure a user's motion movements or environments or VR/AR/MR requirements into 3D stereo sound frequencies and effects and outputs of the speakers 5018A/B/C with a best intelligent calculation and direction. Preferably, one speaker 5018A is a sound driver handling high frequency mostly. Another speaker 5018B handles middle frequency of sound mostly. The third speaker 5018C handles bass frequency range of sound mostly.

The speaker units 5108A/B/C can be one speakers, two speakers, three speakers, or multiple speakers, with any kind of design, position, location, structure, system, method, function, etc., such as a positioning in the same direction, opposite direction, facing each other direction, an off-center arrangement, a front and back arrangement at the same axis or a different axis, an up and down arrangement, a circle arrangement, a parallel arrangement, at same angles, at different angles, inside or outside the earphone 5000, etc.

The intelligent 3D unit 5080 containing sensor units 5080A/B/C receives ail of the user's movements and sound signals from the original sound tracks, or VR/AR/MR requirements, and optionally all of the sensed user's movements or needs, and then analyzes, processes, and directs those original sound tracks or frequencies alone or combined with the sensed and configured user's movements and VR/AR/MR needs into different sound channels and frequencies for those three speakers 5018A, 5018B, and 5018C working with the sound effect structure unit 5032 and sound resonance unit 5036 to create new intelligent 3D stereo sound effects and outputs following or reflecting the user's movements and surrounding environment situations and VR/AR/MR needs.

Inside speaker cup unit 5006 there is a sound effect unit 5032 or other sound effect check members or pieces to create the 3D stereo sound resonance area 5036 within ear cup unit 5006.

The Intelligent 3D earphone 5000 and its intelligent unit 5080 intelligently configure high frequency into the front speakers 5018A/B and bass/middle frequencies into the back speaker 5018C synchronously. Of course, there are many possible ways of 3D stereo sound configuration for achieving better sound stereo effects and outputs with minimized digital sound loss or distortion. For example, the intelligent unit 5080 may configure bass frequency into the front speaker 5018A/B and high/middle frequencies into the back speaker 5018C synchronously.

In this embodiment shown in FIG. 1, there are three speakers (sound drivers) 5018A, 5018B, and 5018C inside the ear cup 5006. In order to arrange these three speakers (triple sound drivers) in a front-and-back straight array or in an angled structure, two speakers 5018A and 5018B are located at the front of the ear cup 5006 with one speaker to handle high frequency and another speaker to handle middle frequency of sound separately and independently, and the third speaker 5018C is located at the back of the ear cup 5006 to handle bass frequency of 3D stereo sound generated or configured from the intelligent unit 5080 with sensing and reacting to a user's movements and surrounding situations.

Therefore, the triple speakers 5018A, 5018B, and 5018C in a straight arrangement create a stage-like real sound delivery system in X-Y-Z three-dimensional (3D) sound stereo space because the triple speakers 5018A, 5018B, and 5018C explore stereo sounds in two dimensions (X-Y Axes) in a wide horizontal broad way, plus, at the same time, the large speaker 5018C delivers very strong sounds, preferably for the bass frequency, from the back to have a Z Axis stereo sound in a deep vertical dimension for X-Y-Z 3D stereo surrounding sound effects with bass/mid/high sound frequencies.

The ear cup 5006, speakers 5018A/B/C, sound effect unit 5032, and sound resonance area or space or unit 5036 can be any kind of design, shape, structure, method, function, system, material, format, etc.

Generally speaking, the intelligent unit 5080 and its sensor units 5080A/B/C and speaker units 5018A/B/C have the following functions and work flows and systems of sensing, analyzing, and configuring at best value, synchronously and collaterally, as follows:

First, sensing or detecting a user's movements or surrounding environments or situations or needs with a certain sense mode selected by the user, such as VR/AR/MR/AI mode, etc.;

Second, receiving or performing original sound tracks and frequencies of X-Y-Z 3D stereo sound working in the sound effect structure 5032 and sound resonant unit 5036;

Third, intelligently analyzing, processing, and configuring the first point and second point together with a computerized best value calculation system and program to generate new X-Y-Z 3D stereo sound effects and outputs for real world or virtual world of VR/AR/MR/AI, or of mixtures of these;

Fourth, intelligently directing the new X-Y-Z 3D stereo sound channels and frequencies into different speakers 5018A/B/C working with the sound effect structure 5032 and sound resonant unit 5036; and

Fifth, delivering the new X-Y-Z 3D stereo sound effects and outputs into a user's ears to satisfy the user's needs for X-Y-Z 3D stereo sound real-situation or real-stage enjoyments, or VR/AR/MR/AI, or mixtures of some or all of them, or all other needs if possible.

Of course, those steps can be adjustable or rotatable or interchangeable any time and anywhere If needed. For example, the second one can become the first one and the first one can become the second one, etc.

There are many possible sound frequency and driver position combinations for those three speakers 5018A/B/C, such as having a straight arrangement at the front and the back or at a parallel side structure, or mix positions, or angle positions, in the same direction or different direction or opposite direction, inside of the ear cup 5006 or earphone 5000, as detailed in U.S. Pat. No. 7,697,709 and No. 8,515,103.

The intelligent 3D earphone 5000 includes an adjustable headband unit 5002 for up or down movement and to hold the left and right parts of earphone 5000. An adjustable holder unit 5004 is connected to headband clip unit 5002 at the left and right ends of earphone 5000. Each holder unit 5004 is connected at the topside of an ear cup unit 5006. Ear cup unit 5006 contains an independently adjustable ear speaker unit 5018 at the center of the portion of earphone 5000 for delivery of sounds from earphone 5000 to a user's ear hearing system. Ear cup unit 5006 also contains a sound conceal and sound direction adjustable filter and delivery unit 5020. The speaker unit 5018 may include 3 speaker units 5018A/B/C.

All units may vary in design, shape, structure, system, method, function, format, and material if needed to apply into the various embodiments of earphones shown in FIGS. 1 to 2B and 5 to 7.

All units and functions and structures explained above and shown in FIGS. 1 to 7 may be used, applied, or inter-exchanged in any figure of this application for all types of earphones and headphones if needed.

All units and the outside and inside intelligent 3D earphone 5000 may be with different designs, methods, formats, systems, shapes, materials, and structures if needed.

There can be two speakers 5018A and 5018B designed and arranged inside the intelligent 3D earphone 5000 as shown in FIG. 1A. Also, there can be just one speaker 5018 designed and arranged inside the intelligent 3D earphone 5000 as shown in FIG. 1B.

FIG. 1A shows that the Intelligent 3D earphone 5000 and its intelligent unit 5080 detect, analyze, process, and configure a user's motion movements and VR/AR/MR requirements into 3D stereo sound frequencies and effects and outputs of the speakers 5018A/B. Preferably, one speaker 5018A is a sound driver handling high frequency mostly. Another speaker 5018B handles bass and middle frequencies of sound mostly.

The intelligent 3D unit 5080 containing sensor and processor units 5080A/B/C receives all of a user's movements and sound signals from the original sound tracks, alone or combined with the sensed user's movements or VR/AR/MR needs, and then analyzes and directs those original sound tracks or frequencies, alone or combined with the sensed and configured user's movements and VR/AR/MR needs into different sound channels and frequencies for those three speakers 5018A and 5018B working with the sound effect structure unit 5032 and sound resonance unit 5036 to create new intelligent 3D stereo sound effects and outputs following and reflecting the user's movements and VR/AR/MR needs and surrounding environment situations.

Inside speaker cup unit 5006 there is a sound effect member or piece 5032 and other sound check members or pieces to create a 3D stereo sound resonance area 5036 within ear cup unit 5006.

The intelligent 3D earphone 5000 and its intelligent unit 5080 configure high frequency into one speaker 5018A and bass/middle frequencies into another speaker 5018B independently and synchronously. Of course, there are many possible ways of 3D stereo sound configuration for achieving better sound stereo effects and outputs with minimized digital sound loss or distortion.

In this embodiment shown in FIG. 1B, there are two speakers (sound drivers) 5018A and 5018B inside the ear cup 5006. These two speakers (two sound drivers) 5018A and 5018B can be designed in a parallel side-by-side array, or in a front-and-back straight, array, or in a an angled structure, in the same direction, or an opposite direction, or a different direction inside the ear cup 5006 or inside each self isolated sound chamber, to handle high/mid/bass frequencies of 3D stereo sound generated or configured from the intelligent unit 5080 with sensing and reacting to a user's movements and VR/AR/MR needs and surrounding situations.

Therefore, the two speakers 5018A and 5018B in a parallel or straight arrangement create a stage-like real sound delivery system in X-Y-Z three-dimensional (3D) sound stereo space because the two speakers 5018A and 5018B explore 3D stereo sounds in three dimensions (X-Y axes) in a wide horizontal way, plus, at the same time, can preferably use bass frequency, from the back to front to have a Z-Axis stereo sound in a deep vertical way for X-Y-Z 3D stereo surrounding sound effects and outputs with bass/mid/high sound frequencies.

There are many possible sound frequency and driver position combinations for those two speakers 5018A/B having a straight arrangement at the front and the back or at a side by side parallel structure or angled structure e or opposite to each other or facing each other inside the ear cup 5006 or earphone 5000, as detailed in U.S. Pat. No. 7,657,709 and No. 8,515,103.

FIG. 1B shows that the Intelligent 3D earphone 5000 and its intelligent unit 5080 detect, analyze, process, and configure a user's motion movements and VR/AR/MR requirements into 3D stereo sound frequencies and effects and outputs of the speaker 5018A. Preferably, one speaker 5018A is to handle all high frequency and bass and middle frequencies of sound mostly.

The intelligent 30 unit 5080 containing sensor units 5080A/B/C receives all of a user's movements and sound signals from the original sound tracks, separately or combined with the sensed user's movements or VR/AR/MR needs, and then analyzes and directs those original sound tracks or frequencies, separately or combined with the sensed and configured user's movements and environments and VR/AR/MR needs into different sound channels and frequencies for the speaker 5018A working with the sound effect structure unit 5032 and sound resonance unit 5036 to create new intelligent 3D stereo sound effects and outputs following or reflecting the user's movements and VR/AR/MR needs and surrounding environment situations.

Inside speaker cup unit 5006 there is a sound effect unit 5032 and other sound effect members or pieces to create a 3D stereo sound resonance area 5036 within ear cup unit 5006.

The intelligent 3D earphone 5000 and its intelligent unit 5080 configure high, bass/middle frequencies into one speaker 5018A for 3D stereo sound generated or configured from the intelligent unit 5080 with sensing and reacting to a user's movements and VR/AR/MR needs and surrounding situations.

There are many possible sound frequency and driver position combinations for the one speaker 5018A having many different structures or methods or combinations or arrangements, as detailed in U.S. Pat. No. 7,697,709 and No. 8,515,103.

FIG. 1C shows another embodiment of the intelligent 3D earphone 5000. There are some mini motors 5018AM/BM/CM and related mini track units 5018AT/BT/CT installed inside the earphone 5000. The mini motor 5018AM and track unit 5018AT move or turn the speaker 5018A forward or backward or at angles. The motor 5018BM and track unit 5018BT move or turn the speaker 5018B forward or backward or at angles. The motor 5018CM and track unit 5018CT move or turn the speaker 5018C forward or backward or at angles, operated by auto sets or manual operations from the control wheel or buttons or input units 5018AMT/BMT/CMT or by an app, or both, at the same time and same pace.

The input control units 5018AMT/BMT/CMT of the intelligent 3D earphone 5080 can be buttons, wheels, keys, arrows, or a touch panel, or a screen panel, and are able to be used in the various embodiments shown in FIGS. 1 to 7, with any kind of input design, format, structure, method, system, function, material, etc.

The motor units 5018AM/BM/CM and track unit 5018AT/BT/CT can be any kind of design, method, structure, system, format, material, function, etc.

FIGS. 2, 2A, and 2AA show that the intelligent earphone 5000 contains a screen or display unit 5098 to display multiple function icons 5088 in graphic format, or list format, or number format, or letter format, or symbol format, or touch panel format, or key board format, etc. The multiple function icons 5088 are to display and carry out many functions, such as display modes 5088A, 3D sense modes 5088B, 3D intelligence modes 5088C, 3D sound configuration modes 5088D, sport modes 5088E, safety modes 5088P, communication modes 5088G, 3D vision/sound modes 5088H, VR/AR/MR modes, game modes, a drive mode 5088T, a music/visual play made 5088T, an input mode 5093MT, etc. The communication modes 5088G are for all kind of communications, e.g. cell phone, internet, wireless, email, IM, WeChat®, apps, etc., in a wireless or cable communication.

The display unit 5098 can have many display formats or systems if needed, such as multiple graphic icons, graphic interfaces, lined icons or lists, a button system, a touch system, a wheel system, an air wave system, an audio/voice control system, an eye/eyeball/iris/pupil/vision control/identification system, a multiple screen-screen system, a voice command and recognition/identification system, a voice operated control system, and a mini multiple player or a mini mobile controller, etc.

The display unit 5098 has the 3D sound movement digits, such as N2 W1 Z0, to indicate a user's movement and the following intelligent 3D sound stereo movement North 2, West 1, Z point 0, in 2D format or 3D format, or 3D graphic format. Those digits can be auto configured or controlled or performed automatically or by manual input and can be changeable, adjustable, or editable, based on a user's needs at the different time or at the same time.

There are a switch unit 5062 and a light indicator unit 5064 and an input unit 5098MT on the display unit 5098. The light indicator unit 5064 is to indicate battery level and wireless signal level together or separately.

The intelligent 3D earphone 5000 has the 3D vision unit 7000 and the microphone unit 5068. The 3D vision unit 7000 is an eye glass screen display or eye glass multiple player or eye glass mobile input/output device to produce ubiquitously computerized multiple 2D or 3D visions directly associated with the intelligent 3D earphone 5000 for virtual reality functions, such as VR/AR/MR functions or systems. The 3D vision unit can be similar to Google Glass, Gear VR, Daydream, PSVR, etc. The 3D vision unit 7000 is attachable and detachably mounted on the intelligent 3D earphone 5000. The 3D vision unit 7000 is working with the intelligent 3D earphone 5000 from a user's movements and VR/AR/MR requirements to create new 3D stereo sound effects and outputs to combine with now 3D visions synchronously, simultaneously, and collaterally.

The 3D vision unit 7000 may have its own intelligent unit 7080 and its sensors 7080A/B/C to achieve 3D real stereo sound, 3D virtual Reality (VR) sound, 3D Augmental Reality (AR) sound, 3D Mix Reality (MR) sound, 3D Artificial Intelligent (AI) sound, 3D Holography sound, and combinations of any kind of VR and AR and MR and AI and 3D Holography video and audio.

When a user wearing tho intelligent 3D earphone 5000 with the 3D vision unit 7000 turns his or her head to right, he or she will see the 3D vision unit 7000 displaying all real wide angle vision to his or her right turn. At the same time, he or she will hear the intelligent 3D earphone 5000 displaying the new 3D stereo sound effects and outputs that follow and result from his or her right turn automatically and synchronously. In this manner, the user receives real right turn 3D vision and right turn new 3D stereo sound effects and outputs simultaneously, just like if he or she were to make a right turn in a real world.

The 3D vision unit 7000 can work independently or separately. The 3D vision unit 7000 and intelligent unit 5080 contain camera and video and speaker and microphone functions working together or separately.

For further continuous development, there is a brain sensor unit 5080M attachable to the intelligent 3D earphone 5000. Ideally, the brain sensor unit 5080M touches the user's head temple area to obtain the brain electronic wave data. The brain sensor unit 5080M may contain several brain spot sensors to obtain more brain electronic data from mind movements to generate real world or virtual world 3D stereo sound effects and outputs.

For further continuous development, there is an eye sensor unit or vision sensor unit 5080V attachable to the intelligent 3D earphone 5000. Ideally, the eye sensor unit 5080V is close to the user's eye area to obtain the eye movement electronic wave data or eyeball and iris and pupil movement data. The eye sensor unit 5080V may contain several eye/eyeball/iris/pupil spot sensors to obtain more eye/eyeball/iris/pupil movement electronic data for eye or vision movements or for eye ID, etc.

The intelligent unit 5080 and sensor units 5080A/B/C/V and 3D vision unit 7000 configure automatically together to achieve intelligent 3D stereo sound effects and outputs by following and reflecting a user's eye or eyeball or iris or pupil movements. For example, when a user moves his eyes or eyeballs or iris or pupils from his or her left side to right side in a real world or in VR/AR/MR/AI world, he or she can naturally hear the intelligent 3D stereo sound effects and outputs from the intelligent 3D earphone 5000 from the same movement and direction from the left to right, at the same speed, synchronously, simultaneously and collaterally.

The vision unit 7000, 3D earphone 5000, and the earphone player 8000 can work together for real world or virtual visions as VR/AR/MR/AI, for Intelligent 3D stereo sound effects and outputs, and for all intelligent cellular phone multiple functions in parallel synchronously, simultaneously, and collaterally.

The vision unit 7000 and brain unit 5080M and eye unit 5080V can be any kind of design, shape, method, structure, system, format, material, function, etc.

FIG. 2A shows that the intelligent 3D earphone 5000 has the display unit 5098 with a detachable function. In this detachable function, the display unit 5098 can wirelessly become a mini remote or mobile controller, or communication and play tool, such as a wireless mini multiple player, portable device, cell phone, electrical watch, hand band, head band, walkie-talkie, medical device, etc.

The intelligent 3D earphone 5000 contains a detachable frame system 5098AA so that the screen unit 5098 containing intelligent unit and sensor units 5080/5080A/B/C is attachable or detachable. Thus, the screen unit 5098 can be used for a mini mobile controller/input/output or a mini multiple player (MP) or a mini operation center if needed.

The screen or display unit 5098 displays multiple function icons 5088 in graphic format, or list format, or number format, or letter format, or symbol format, touch panel format, key board format, etc. The multiple function icons 5088 are to display and carry out many functions, such as display modes 5088A, 3D sense modes 5088B, 3D intelligence modes 5088C, 3D sound configuration modes 5088D, sport modes 5088E, safety modes 5088F, communication modes 5088G, 3D vision/sound modes 5088H, a drive mode 5088I, 3D VR/AR/MR modes 5088VAM, a music/visual play mode 5088T, an input mode 5098MT, etc. The communication modes 5088G are for all kind of communications, e.g. cell phone, internet, wireless, email, IM, WeChat®, app, etc.

The display unit 5098 can have many display formats or systems if needed, such as multiple graphic icons, graphic interfaces, lined icons or lists, a button system, a touch system, a wheel system, an air wave system, an audio/voice control system, an eye/vision control system, a multiple screen-screen system, a VR/AR/MR system, etc.

The display unit 5098 has the 3D sound movement digits, such as, N2 W1 Z0 to indicate a user's movement and followed up intelligent 3D stereo sound movement North 2, West 1, Z point 0, in 2D format or 3D format, or 3D graphic format. Those digits can be auto configured or controlled or performed automatically or by manual input and can be changeable, adjustable, or editable based on a user's needs.

There are a switch unit 5062 and light indicator unit 5064 and input unit 5098MT on the display unit 5098. The light indicator unit 5064 is to indicate battery level and wireless signal level together or separately.

FIG. 2B shows one embodiment of that app design 8006 of the earphone player 8000 for the intelligent 3D earphone 5000. The app 8006 of the earphone player 8000, the 3D earphone 5000, and the vision unit 7000 work together to create new 3D stereo sound effects and outputs in parallel synchronously, simultaneously and collaterally, in one way, two ways, or multiple ways, with one direction, two directions, or multiple directions if needed.

The earphone player 8000 contains an app unit 8006, a shell unit 8060, a switch unit 8022, a wireless or cable unit 8068, a screen unit 8018 with input and microphone and speaker functions, and a display area 8012, or additional parts, etc.

The app design 8006 contains the intelligent 3D earphone Main Menu 8082, Play Mode 8084 for music/visual play or game play or any play, Function Mode 8066, Setting 8088, Sound Effect Mode 8092S, Vision Mode 8092V, Communication 8020, and Edit Bar 8024, etc.

The design of app 8006 displays multiple function icons in graphic format, or list format, or number format, or letter format, or symbol format, touch panel format, key board format, etc., for many formats and icons and modes and functions as shown in FIG. 2B and as described in the related explanations.

Also, the app 8006 can have many display formats or systems if needed, such as multiple graphic icons, graphic interfaces, lined icons or lists, a button system, a touch system, a wheel system, an air wave system, an audio/voice control system, a voice recognition/identification system, an eye/vision control system, a multiple screen-screen system, a VR/AR/MR system, etc.

The Sound Effect Mode 8092S is to operate the motors 5018AM/BM/CM and track units 5018AT/BT/CT inside the ear cup 5006 with auto set function or manual operation selection.

The Vision Mode 8092V is to work with the vision devices, such as VR/AR/MR devices.

Therefore, the intelligent 3D earphone 5000 can co-work with any kind of app 8006 of the earphone player 8000 and vision device 7000 together in both ways or multiple ways at the same time. The intelligent 3D earphone 5000 and any kind of app 8006 and any kind of vision device 7000 can exchange or co-work or co-do self-configuration of all kind of data or files anytime and anywhere, by wireless communication or by cable line.

In other words, the intelligent 3D earphone 5000 can operate the app 8006 and vision unit 7000 together. At the same time, the app 8006 can operate the intelligent 3D earphone 5000 and vision unit 7000 together too. At the same time, the vision device 7000 can operate the intelligent 3D earphone 5000 and app 8006 all together also, in one way, or two ways, or multiple ways, synchronously, simultaneously and collaterally

The earphone player 8000 and the app 8006 and all menus and ail units inside the app 8006 can be any kind of design, format, shape, function, structure, system, method, material etc.

FIG. 3 shows further details of the intelligent 3D stereo sound effects and outputs 5290 configured and directed by the intelligent unit 5080 and its sensor and processor units 50580A/B/C. Sound is with a source property and a direction property. A human being has a hearing sense of sound sources, sound directions, and sound movements. When the sensor units 5080A/B/C sense a user's movement with the sound source/direction fixed, his or her head turns to North 2 and East 1, and his body position Z does not move, the output band indicator 5290 shows Channel 1 (X axis) up 2 levels, Channel 2 (Z point) 0 still, Channel 3 (Y axis) up 1 in three dimensional directions: vertical (North or South), horizontal (East or west), and deep (Z axis direction). The old level 5292A/B/C is changed to the new level 5294A/B/C. Under the new level 5294A/8/C, a user can hear the intelligent 3D stereo sound changed to be stronger at north 2 and east 1 direction. Just like in the real world, when a user turns his or her head to left side, the sound effects he or she hears with the earphone is changed north-east side stronger accordingly.

The sound channel levels can be replaced with any kind of sound frequency levels or indicators.

The sound source/direction may be fixed, or not fixed, or movable, or changeable, outside from the intelligent 3D earphone 5000 or inside the earphone 5000.

In details of FIGS. 2, 2A, 2B, and FIGS. 3, 3A, and 3B, at the beginning when a user sits on a chair facing North, the intelligent 3D earphone and its intelligent unit 5080 sense no change and cause the indicator 5084 to show “N0E0Z0”. Then the user turns his or her face toward North and East. At that time, the intelligent 3D earphone 5000 and its intelligent unit 5080/5080A/B/C sense this movement and cause the sense indicator 5084 to show “N2E1Z0”. When the indicator 5084 shows “N0E0Z0”, the intelligent unit 5080 will not add, reduce, or change in any channel, level or band 290 of the original sound play output. When the indicator 5084 shows “N2E1Z0”, the intelligent unit 5080 will automatically follow the mode selected by the user to add, reduce or balance all channels or levels 5290 to create new intelligent 3D stereo sound effects and outputs from the original stereo sound play output.

As further explained with reference to FIG. 3, under the intelligent 3D stereo sound system, the channel 1 (Y axis) has an original sound stereo output level 5292A, the channel 2 (Z point/axis) has an original sound stereo output level 5292B, and the channel 3 (X axis) has an original sound stereo output level 5292C. Usually the channel 1 is set up in the North/South direction as Y axis, the channel 2 set up in the Z point/axis or sound depth direction, and the channel 3 set up in the East/West direction as X axis. When the indicator 5084 shows “N2W1Z0”, the channel 1 as vertical effect (North or South—Y axis) has two steps 5294A to add on the original sound stereo play output, the channel 2 as sound depth point (Z points A/B/C) has zero step 5294B to add on the original sound stereo play output, and the channel 3 as horizontal effect (East or West—X axis) has one step 5294C to add on the original sound stereo play output. Thus, at that time, under the intelligent 3D stereo sound effects end outputs generated and configured by the intelligent unit 5080, the user can hear a strong 3D stereo sound from the 3D stereo sound play output with the North side strongest, the East side a little stronger, and with no change for a Z point dimension, just as in a real sound situation and with sound direction or level stereo change effects.

Of course, the channels or levels 1, 2, 3 of band 5290 may be used, replaced, combined, or improved in whole or in part with any kind of function, system and method of any 3D sound stereo/wave/level/frequency controller, 3D sound stereo wave/level/frequency amplifier, or 3D sound stereo wave/level frequency equalizer.

If a user starts to turn his or her head wearing the intelligent 3D earphone 5000 one step to the North, the intelligent unit 5080 can sense this movement and automatically configure new intelligent 3D stereo sound effects and outputs. At the same time, the Z point/axis (Z points A/B/C) will be changed accordingly. The indicator 5084 and 5290 will show “N2E1Z1”. The user can hear new 3D stereo sound developments with his body movements at the same speed automatically and accordingly.

The channels or levels 1, 2, 3 of band 5290, the display 5098, and indicator 5084 may vary In size, design, location, shape, style, material or method and system of operation with more channels or levels.

The indicator 5084 may be in digitalized 2D or 3D graphic format, or virtual 3D display format, or any kind of display format, etc.

The channels or levels 1, 2, 3 of band 5290, the display 5098, and indicator 5084 may be visible or not depending on the user's needs. The display 5098 may have multiple display functions, such as 3D or 2D direction indication, sound stereo output screen, radio screen, or multimedia player screen, etc. A user can select those functions through a mode selection.

The computerized intelligent sound wave/level/frequency controller unit 5080 can be used or applied on any kind of digitalized audio or audio/video device or system in a 3D method or even in a 2D method. For example, the intelligent controller unit 5080 can be used in a wireless or cabled earphone, a regular or traditional earphone system, a regular headset/headphone system, an audio device, an audio/video system, a telephone system, a PC system, a notebook computer, an Internet communication system, a cellular/satellite communication system, a home theater system, a car/ship/airplane audio/video system, a game system, VR/AR/MR/3D Holography systems, in hearing assistance equipment or other suitable system.

In FIG. 3A, when a user faces up north, the left ear cup 5006L is at the loft side Axis X, and a right ear cup 5006R is at the left side of Axis X. At this position, with the sound source/direction fixed from the north down as indicated, the position indicator 5064 shows “L: X−1 Y0 Z0” and “R: X1 Y0 Z0” with Z points A/B/C. When the user moves his or her head to the right side 90 degrees and faces the east side as indicated with the arrow, the position indicator 5064 shows “L: X0 Y1 Z0” and “R: X0 Y−1 Z0”. Those changes are immediately sensed and processed by the intelligent unit 5080 and sensor units 5080A/B/C to generate new 3D stereo sound effects and outputs with the left side speaker(s) sound turned stronger to the north because the left side speaker(s) sound at Axis Y was added 1 point stronger, and with the right side speaker(s) sound turned weaker to the south because the right side speaker(s) sound at Axis Y was reduced 1 point weaker,

Sound is with a source property and a direction property. A human being has a hearing sense of sound sources sound directions, and sound movements. Therefore, a user can hear new 3D stereo sound effects and outputs to follow his or her movements and needs through the intelligent 3D earphone 5000.

The sound source/direction may be fixed, or not fixed, or changeable, or movable, or adjustable, outside or inside the intelligent 3D earphone 5000.

FIG. 3B shows the intelligent 3D earphone 5000 with outside sound source/direction movement. Sound is with a source property and a direction property. A human being has a hearing sense of sound sources, sound directions, and sound movements. When the outside sound source/direction (environment or situation) is moved from Move A to Move B, the intelligent unit 5030 and sensor units 5080A/B/C sense and process that movement and automatically generate new 3D stereo sound effects and outputs by following and reflecting that sound movement. Move A is with L: X−2 Y2 Z0. Move B is with R: X2 Y2 Z0. Obviously, the sound movement will be left side weaker (X−2) and right side stronger (X+2) as the user's standing point does not change (Z points A/B/C). The intelligent unit 5080 will process those data changes sensed by the sensor units 5080A/B/C, process them into new sound configurations, and send those new sound configurations into the speakers 5018A/B/C to achieve intelligent 3D stereo sound effects and outputs by following and reflecting the outside sound source/direction movement. Preferably, the intelligent unit 5080 sends one new sound configuration to the left earcup speakers with the sound becoming weaker and weaker (X−2), and sends another new sound configuration to the right earcup speakers with the sound becoming stronger and stronger (X+2).

For example, a user wears the Intelligent 3D earphone with a connection to virtual world vision and sound. As he or she sees a car moving from front left to front right in a virtual world, similar to Move A to Move B, he or she can hear that car-movement sound moving from his front left to front right in the intelligent 3D earphone 5000 simultaneously and synchronously, just like happens in the real world.

The outside sound source/direction movement can be in the real world, or in any VR/AR/MR/3D Holography world, or in a mixed real world and virtual world.

All units may vary in design, shape, structure, system, method, function, and material if needed to apply into the various embodiments of earphones shown in FIGS. 1 to 7.

All units and functions and structures explained above and shown in FIGS. 1 to 7 may be used, applied, or inter-exchanged in any figure of this application for all types of earphones and headphones if needed.

FIGS. 4, 4A, and 4B show how the intelligent unit 5080 senses, detects, analyzes, processes, and configures a user's motions or VR/AR/MR requirements into 3D stereo sound effects and outputs automatically.

FIG. 4 shows a pair of earphone sound curves, namely a left sound curve of a left earphone piece, and a right sound curve of a right earphone piece. The vertical line is the Y axis. The horizontal line is the X axis. The Z point is at the 90 degree cross point 0 of X axis and Y axis as X-Y-Z 3 Dimension Stereo Sound Space, especially in VR/AR/MR/AI worlds. There are movement section lines for the X axis and the Y axis. Those section lines may be adjustable with the same space, or different spaces according to different modes configured by the intelligent unit 5080 for different functions.

The left and right curve charts can be the same or different based on needs.

FIG. 4A explains how the intelligent 3D stereo sound system 5080A/B/C and Z points A/B/C work and how the intelligent 3D stereo sound effects and outputs are created from the automatic configuration of the intelligent unit 5080 following a user's movements or VR/AR/MR requirements. There is a pair of earphone sound curves, namely the left sound curve and the right sound curve. The left sound curve (curve 1) line of left earphone piece with Y1 axis, X1 axis, and Z1 point/axis (with z point A or B or C) has 5294ZP as the original situation. The right Bound curve (curve 1) line of right earphone piece is also with Y1 axis, X1 axis, and Z1 point/axis (with Z point A or B or C) 5294ZP as the original situation.

A user turns his head to the right at North 2, East 1, and Z point 0, with the sound source/direction fixed. The intelligent unit 5080 senses and processes this movement and configures it into new 3D stereo sound effects and outputs. Because of the user's turn to right, it is better and easier to use the right sound curve line to show new 3D stereo sound effects and outputs to work under the intelligent unit 5080's controls and configurations. The curve 1 is the original sound line. The curve 2 is the new intelligent 3D stereo sound effects and outputs controlled and configured by the intelligent unit 5080 following the user's movements. The curve 2 is moved up to Y2 and X1 and Z2 point with the new 3D stereo sound effects and outputs so that the right side is stronger to reflect the user's head turn to the right to match that the right side sound would be stronger and closer in the real world.

If a user continues to turn his or her head with the intelligent 3D earphone 5000, Curve 3 is created with other new intelligent 3D stereo sound effects and outputs controlled and configured by the intelligent unit 5080 according to the user's continued movements. The curve 3 is further continuously moved up to Y3 and X2 and Z3 point with the newer 3D stereo sound effects and outputs becoming right side stronger and stronger to reflect that the user's head continues to turn to the right side, which matches that the right side sound would be stronger and closer in the real world.

The Z point/axis (ZP) 5294ZP (Z point A or B or C) can get the best value calculation from the Z area stereo data for best new 3D stereo sound effects and outputs, especially for the sound depth, Z axis sound space.

The Z point/axis 5294ZP can be any or a mixture of Z point A or B or C and can be pre-set or automatically self-adjusted for sense point stereo measurements.

There are beginning time differences set up in advance or automatically set or reset up for reactions or configurations, for example with around 2-3 seconds to start the reaction function of the intelligent unit 5090 and its sensor units 5080A/B/C.

There are time differences for returning back, to the original state, with those time differences being pre-set up or automatically set up or reset up for returning back to the original condition if a user stops turning his or her head and sits back straight forward, for example with around 2-5 seconds to let the intelligent 3D earphone 5000 change back to the original condition naturally and smoothly.

The left and right curve charts can be the same or different based on needs.

FIG. 4B is another explanation how the intelligent 3D stereo sound system 5080A/B/C and Z points A/B/C work and shows how the intelligent 3D stereo sound effects and outputs are created from the automatic best configuration of the intelligent unit 5080 following a user's movements or VR/AR/MR requirements at the Z area/axis (ZR) sense motion 5294ZR. There is a pair of earphone sound curves, namely the left sound curve and the right sound curve. The left sound curve (curve 1) of the left earphone piece is with Y1 axis, X1 axis, and Z1 area/axis (with Z point A or B or C) as the original situation. The right sound curve (curve 1) of the right earphone piece is also with Y1 axis, X1 axis, and Z1 area/axis (with Z point A or B or C) as the original situation.

The left and right curve charts can be the same or different based on needs.

There are two types of sense motions: The first one is the accurate sense point. We call that the Z point/axis (ZP) 5294ZP at mm or cm measurement as shown in FIG. 4A. Second one is the sense stereo area (ZR) 5294ZR. We call that the Z area/axis (ZR) 5294ZR. The Z point/axis (ZP) 5294ZP is very good for accurate sense functions such as a pin point sense, a space center sense, an accurate distance sense, a radiation sense, etc. The Z area/axis 5294ZR is very good for stereo format sense functions, such as the angle sense, the space area movement sense, the environment sense, the fast moving sense, the stereo space sense, etc. The Z area/axis (ZR) 5294ZR can obtain the best value calculation from the Z area stereo data for the best new 3D stereo sound effects and outputs, especially for the sound depth, Z axis sound space. This is one of the benefits for the Z area/axis system 5294ZR by using fuzzy mathematics and stereo space format or other best value calculation methods, which is very good for VR/AR/MR requirements.

With FIG. 4B's Z area/axis sense motion (ZR) 5294ZR, a user turns his or her head to the right at North 2, East 1, and Z area 0, with the sound source/direction fixed. Sound is with a source property and a direction property. A human being has a hearing sense of sound sources, sound directions, and sound movements. The intelligent unit 5080 senses and processes this movement and configures it into new 3D stereo sound effects and outputs. Because of the user's turn to right, it is better and easier to use the right sound curve line to show new 3D stereo sound effects and outputs to work under the intelligent unit 5080's controls and configurations. The curve 1A is the original sound line. The curve 2A is the new intelligent 3D stereo sound effects and outputs controlled and configured by the Intelligent unit 5080 following the user's movements. The curve 2A is moved up to Y2 and X1 and Z2 area with the new 3D stereo sound effects and outputs becoming right side stronger to reflect the user's head turn to the right which matches that the right side sound would become stronger and closer in a the real world with such a movement.

If a user continues to turn his or her head with the intelligent 3D earphone 5000, Curve 3 is created with new intelligent 3D stereo sound effects and outputs controlled and configured by the intelligent unit 50SO following the user's continued movements. The curve 3 is further continuously moved up to Y3 and X2 and Z3 area with the newer 3D stereo sound effects and outputs becoming even stronger for the right side to reflect that the right side sound would become stronger and closer in the real world based on the user's head continually turning to the right side.

The Z area/axis 5294ZR can be any of z point A or B or C or a combination of these and can be pre-set or automatically self-adjusted for sense area stereo measurement a.

There are beginning time differences set up in advance or automatically set or reset up for reactions or configurations, for example with around 2-3 seconds to start the reaction function of the intelligent unit 5080 and its sense units 5080A/B/C.

There are time differences for returning back to the original state, with those time differences being pre-set up or automatically set up or reset up for returning back to the original condition if a user stops turning his or her head and sits back straight forward, for example with around 2-5 seconds to let the intelligent 3D earphone 5000 change back to the original condition naturally and smoothly.

The left and right curve charts can be the same or different based on needs.

All functions or methods or systems of FIGS 4-4B can be used in a VR/AR/MR/AI virtual world or real world or a mixture of both worlds. For example, the functions or methods or systems of the Z area/axis (ZR) 5094ZR and Z point/axis (ZP) 5094ZP can be used for all movements ox situations or changes or developments in a VR/AR/MR/AI virtual world or virtual space or virtual time to generate new 3D stereo sound effects and outputs.

The sound source/direction may be fixed, or not fixed, or movable, or changeable, or adjustable, outside or inside the intelligent 3D earphone 5000.

All units may vary in design, shape, structure, system, method, function, and material if needed to apply into the various embodiments of earphones shown in FIGS. 1 to 7.

All units and functions and structures explained above and shown in FIGS. 1 to 7 may be used, applied, or inter-exchanged in any figure of this application for all types of earphones and headphones if needed.

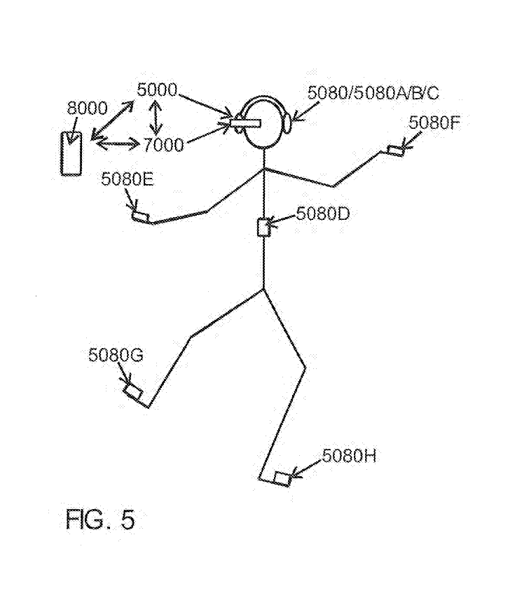

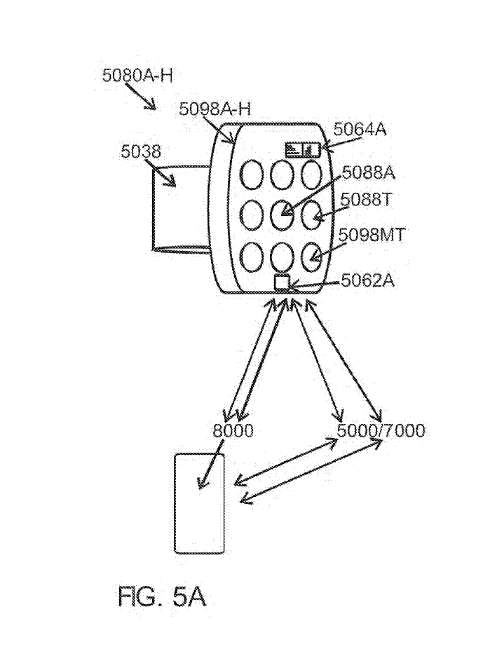

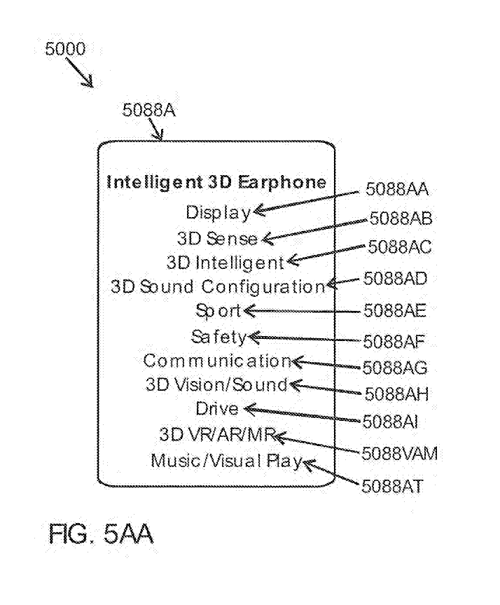

FIGS. 5 and 5A show another embodiment of the intelligent 3D earphone 5000 with a wearable system or structure for sports, health, training, entertainments, works, studies, medical issues, robot or Artificial Intelligent (AI) Wear, AI tool, AI equipment, 3D Holography, ate. A user wears the intelligent 3D earphone 5000 containing the inside intelligent unit/sensor and processor units 5080/5080A/B/C and with 3D vision tool 7000 detachable. There are more outside sensor and processor units 5080D/E/F/G/H to put on the user's body to sense the user's body movements. The sensor unit 5080D is placed at the chest area of the user. The sensor unit 5080E is on the right hand. The sensor 5080F is on the left hand. The sensor 5080G is on the right foot. The sensor 5080H is on the left foot. More outside sensor units can he applied if needed. For example, one or more sensor units can be installed within the head band 5002 of the intelligent 3D earphone 5000 or on the backside of a user's body, etc.

Therefore, a user's whole body movements are sensed by the intelligent unit 5080. The intelligent unit 5080 configures those sensed movements into new 3D stereo sound effects and outputs with the 3D vision tool 7000 together.

The sensor units 5080A to H can be located inside or outside the earphone 5000. In any embodiment of this invention, any sensor unit 5090A to C or to H can be independent or separate from the intelligent unit 5080 if needed.

There are many sense or play modes on those sensors 5080A to H. For example, the center sensor unit 5080D is to sense the user's chest movements or temperatures. The hand sensor units 5080E/F are to sense the user's hand movements or assigned audio or music instruments or game tools, such as different violins, speakers, drums, letter writing and graphic drawing or painting on air or on paper, or game wireless controller like Wii U Remote Controller, etc. The foot sensor units 5080G/H are to sense the user's foot movements or assigned audio or music instruments or game tools, such as drums, running, walking, jumping, etc.

The intelligent unit 5080 can sense and process those movements and configure them into new 3D stereo sound effects and outputs by generating electronic signals into the intelligent 3D earphone speakers 5018A/B/C and 3D stereo sound effect 5032 and sound resonance unit 5036 as shown in FIGS. 1 to 7.

There is a communication tool and/or earphone player 8000 to work with the intelligent earphone 5000 and its intelligent unit 5080 together. The communication tool or earphone player 8000 can be any kind of cellular phone, multiple player, smart phone, electronic portable device, music electronic instruments, electronic watch, laptop, notebook, PC, VR/AR/MR/AI or 3D Holography devices, app, etc.

The earphone player 8000 may contain its own intelligent unit 8080 and sensor/processor units 8080A/B/C, very similar to the intelligent 3D earphone's intelligent unit 5080 and sensor/processor units 5030A/B/C. Those 2 sets of the intelligent units or the earphone player 8000 and 3D earphone 5000 are to work together to create new 3D stereo sound effects and outputs in parallel synchronously, simultaneously and collaterally.

The 3D vision unit 7000 can be any kind of 2D or 3D vision device, such as for one eye like Google Glass, or for both eyes like Virtual Glass, Gear VR, Daydream, PSVR, or any kind of VR/AR/MR/AI device, etc.

The 3D vision unit 7000, 3D earphone 5000 and its sensor units 5080A to H, and the earphone player 8000 can work together for VR/AR/MR/AI virtual visions (virtual reality functions), 3D Holography, intelligent 3D stereo sound effects and outputs, and all intelligent cellular phone multiple functions in parallel synchronously, simultaneously, and collaterally.

FIGS. 5A and 5AA show those intelligent and sensor units 5080A-H containing each screen or display unit 5098A-H to display multiple function icons 5088A in graphic format or list/letter format or icon format or symbol format. The multiple function icons 5088A are to display and carry out many functions, such as display modes 5088AA, 3D sense modes 5088AB, 3D intelligence modes 5088AC, 3D sound configuration modes 5088AD, sport modes 5068AE, safety modes 5088AF, communication modes 5088AG, 3D vision/sound modes 5088AH, drive mode 5088AI, music/visual play mode 5088AT, 3D VR/AR/MR modes 5088VAM, input mode 5098MT, etc. The communication modes 5088AG are for all kind of communications, e.g. cellular phone, internet, wireless, email, IM, WeChat®, camera/video, app, etc.

The display units 5098A-H can have multiple screens or icons if needed.

The display units 5098A-H have the 3D sound movement digits, such as, N2 W1 Z0 to indicate a user's movement and corresponding new intelligent 3D sound stereo movement North 2, West 1, Z point 0. Those digits can be auto configured or controlled or performed automatically or by manual input, and can be changeable, adjustable, and editable, based on a user's needs.

There are a switch unit 5062A, a light indicator unit 5064A, and an input unit 5096MT on the display units 5098A-H. The light indicator unit 5064A is to indicate battery level and wireless signal level together or separately.

The intelligent sensor and processor units 5030A-H can have the same mode or function selected or multiple modes and function selected or different modes or functions selected for each unit 5080A to 5080H. For example, the center unit 5080D has the communication mode selected to work with the communication tool and earphone player 8000. The hand units 5080E-F have writing or drawing or painting modes selected to write letters or numbers or to draw sketches or to paint pictures on air or on paper to configure them into sound playing or letter writing/drawing/painting display, to record them, and edit them in the intelligent 3D earphone 5000. The foot units 5080G-H have a walking or running mode selected to the intelligent 3D earphone 5000.

All those modes above can be selected or played at: the same time, same place, same pace, or at a different time, different place, different pace, or to be inner changeable or self adjustable, synchronously or separately, if needed.

The Intelligent sensor units 5080A-H and display unite 5098A-H can be with sensor functions only, or sensor functions with multiple player (MP) functions and/or mobile controller/input functions together at the same time, and modified into one unit or several units if needed.

The earphone player 8000 may contain its own intelligent unit 8080 and sensor/processor units 8080A/B/C, very similar to the intelligent 3D earphone's intelligent unit 5080 and sensor/processor units 5080A/B/C. Those 2 sets of the Intelligent units of the earphone player 8000 and 3D earphone 5000 work together to create new 3D stereo sound effects and outputs in parallel synchronously, simultaneously and collaterally.

At the same time, the vision unit 7000, 3D earphone 5000, and the earphone player 8000 can work together for VR/AR/MR virtual visions (virtual reality), intelligent 3D stereo sound effects and outputs, and all intelligent cellular phone multiple functions in parallel synchronously, simultaneously, and collaterally.

There is a detachable belt or band 5038 working with the sensor 5080A-H for a user to wear the sensor on hands or feet. The belt or band can be replaced with any kind of Fastener. The design, function, method, shape, type, and material of the belt; or band 5038 may vary.

All units nay vary in design, shape, structure, system, method, function, and material if needed to apply into the various embodiments of earphones shown in FIGS. 1 to 7.

All units and functions and structures explained above and shown in FIGS. 1 to 7 may be used, applied, or inter-exchanged In any figure of this application for all types of earphones and headphones if needed.

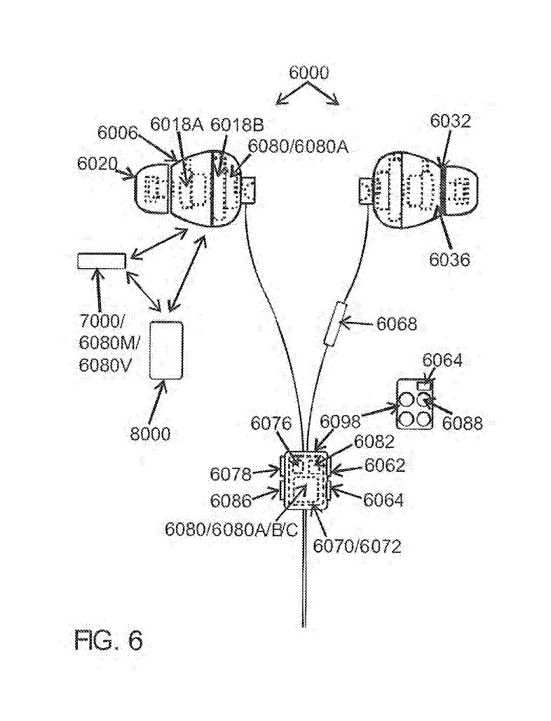

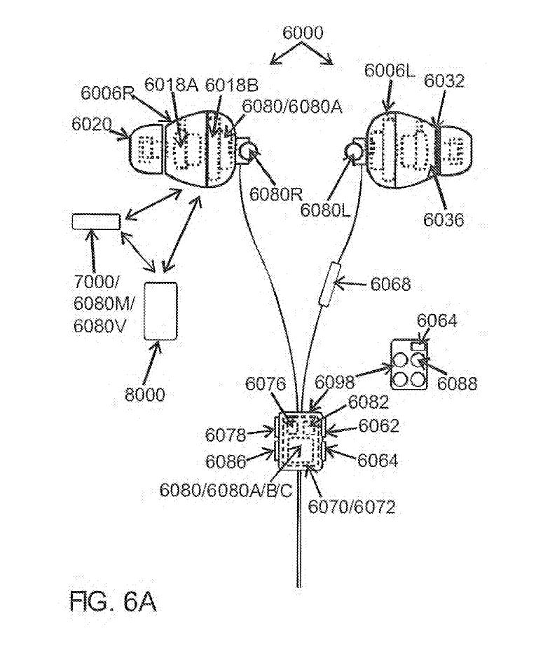

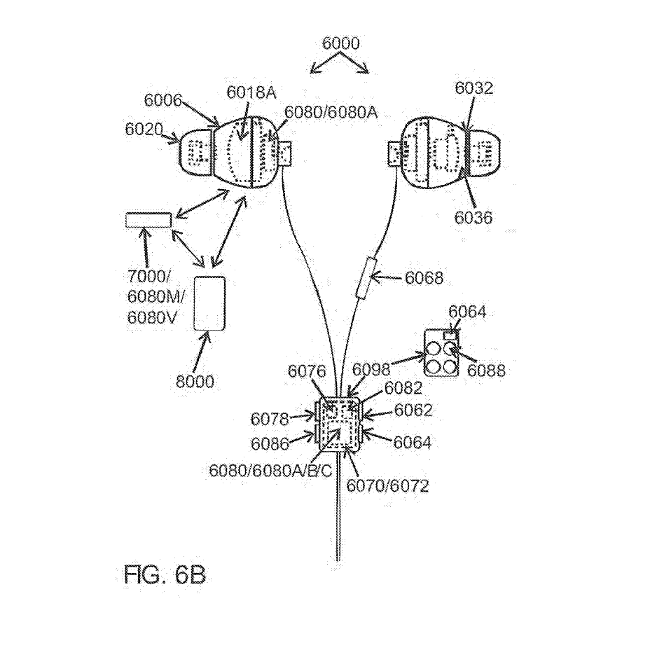

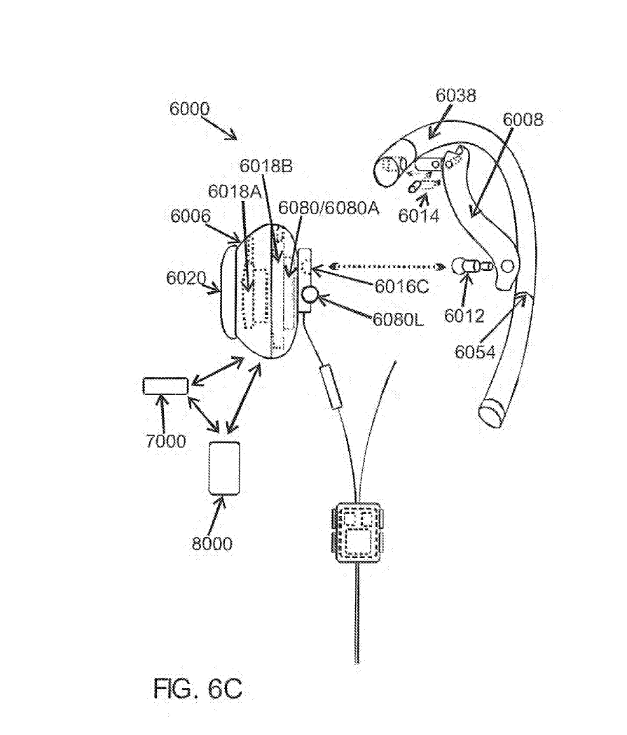

FIGS. 6, 6A, and 6B show another embodiment of the intelligent 3D earphone 6000 containing intelligent unit 6080 and motion and environment sensor/processor units 6080A, 6080B, 6080C inside the earphone 6000. Another set of an intelligent unit 6080 and sensor units 6080A/B/C are inside the multiple player unit 6098 with a cable or a wireless/battery level unit 6064 and a graphic interface unit 6088, a mother board 6070 and CPU unit 6072 with several micro chips, a battery unit 6076, a wireless/cable unit 6078, a microphone unit 6068, a switch unit 6062, a light indicator unit 6064, an integrated micro sound amplifier unit 6082, and a sound purifier unit 6086, etc. At the same time, the computerized intelligent sound controller unit 6080 which can also be an intelligent wave/level/frequency reaction and controller unit is inside the ear speaker cup unit 6006 containing the multiple speaker units 6018A and 6010B working with the sound effect structure unit 6032 and sound resonance unit 6036 together to create intelligent 3D stereo sound effects and outputs.

The intelligent unit 6080 contains motion sensor/processor units 6080A, 6080B, and 6060C to detect a user's body movements and a user's needs for VR/AR/MR/AI to generate automatically a set of self-configured 3D stereo sound effects and outputs. Also, the intelligent unit 6080 contains motion sensor units 6080A, 6080B, and 6080C to detect a user's environment or surrounding or VR/AR/MR/AI requirements to generate automatically a set of self-configured new intelligent 3D stereo sound effects and outputs. The intelligent unit 6080 and computerized motion sensor units 6080A/B/C detect, process, and control the natural motions or VR/AR/MR motions or environment movements and 3D sound frequency configuration system of multiple speaker units that includes 3D stereo sound speaker units 6018A and 6018B.

The intelligent unit 6080 automatically detects, analyzes, processes, records, follows, and directs the result and self auto configuration of those activities or situations or special virtual reality requirements to generate 3D stereo high sound frequency into the first speaker unit 6018A and generate the bass/middle frequencies of 3D stereo sounds into the second speaker unit 6018B, working with the sound effect structure unit 6032 and sound resonance unit 6036 together in order to achieve intelligent 3D stereo sound effects for a very 3strong and powerful bass and resonance/harmony performance stereo in X-Y-Z three dimensional (3D) sound effects under the multiple drivers arrayed in multiple ways.

The ear cup 6006 and speaker units 6018A/B and sound effect unit 6032 and sound resonance/harmony unit 6036 all work together to generate 3D stereo sound effects and outputs, with all their functions, structures, systems, methods, materials, designs, and formats as detailed in U.S. Pat. No. 7,697,709 and No. 8,515,103.

The Intelligent, unit 6080 and sensor units 6080A/B/C can be in one unit, or two units, or multiple units, together or separate or independent.

Any senor unit 6080A to C can be independent or separate from the intelligent unit 6080 if needed.

There can be designed to put 2 sensors 6080R and 6080L into inside or outside the right ear cup 6006R and left ear cup 6006L of the intelligent 3D earphone 6000 separately and independently with any location and any design to detect or sense a user's right side movements/situations and left side movements/situations and then send those sensed data into the intelligent unit 6080 for creation of new intelligent 3D stereo sound effects and outputs, as is shown for example in FIG. 6A.

The Intelligent 3D stereo earphone 6000 can be used for or worked with any kind of VR/AR/MR or any kind of artificial intelligence (AI) or any kind of robot system, AI wear, AI tool, AI equipment, and wearable system, etc.

The design, function, material, shape, size, type, and location of the intelligent unit 6080 and its sensor and processor units 6080A/8/C with mini circuit board and micro chips inside may vary.

The wireless/cable unit 6078 may include a receiver/sender unit 6078A allowing the wireless/cable unit 6078 to deliver or receive from a circumaural wireless stereo radio frequency (RF) system, or an internet server system, or blue tooth, or Wi-Fi system, an app, home and work connection, icloud system, etc.

The CPU/MCP unit 6072 may contain a digital signal processor providing a full range of digital audio output of earphone 6000.

Therefore, intelligent 3D stereo earphone 6000 may be used wirelessly or through a cable in a regular earphone system, a regular headset/headphone system, a cell phone, a smart phone, a multiple player, a radio system, a telephone system, a personal computer (PC) system, a notebook computer, an Internet communication system, a cellular/satellite communication system, a home theater system, a car/ship/airplane audio system, a game, VR/AR/MR devices, ear hearing assistance equipment, an app, or medical equipment, etc.

The Intelligent 3D earphone 6000 contains the sound delivery unit 6020 with several shapes and functions, such as In-Ear, On-Ear, Around-Ear, Over-Ear, etc.

The intelligent unit 6080 and motion sensors 6080A/8/C are to sense or detect a user's body movements. According to a mode pre-selected by the user, the intelligent unit 6080 receives, processes, and analyzes those sensed movements to generate automatically new 3D stereo sound effects and outputs. Thus, a user can hear a new 3D stereo sound to follow and/or reflect his or her movements and his or her desires for VR/AR/MR/AI visual and stereo sound combinations and effects and outputs.

Traditionally, an earphone is only configured to deliver or play sound or audio recorded in certain electronic formats, such as in a CD, an electronic file, or from a hard drive, from the internet, etc. A user is not able to change or update this kind of sound outputs or sound effects when using a traditional earphone. A user's needs or body movements or environments, or surroundings, or virtual reality situations, or natural situations are not related absolutely to any sound output or effect playing in a traditional earphone, in other words, a traditional earphone is only a negative electronic player, is not intelligent, and has nothing to do with and does not react to a user's movements or situations. There is not any connection between the earphone and its user's movements and surrounding situations and they are totally separate.

The intelligent unit 6080 and its sensors 6080A/B/C are intelligently and positively to connect or follow a user's movements and surrounding situations and VR/AR/MR/AI requirements with the earphone sound system automatically at the same time, same pace, and same space, through the self-motivated configuration system generated by CPU unit 6072, memory unit 6074, sound amplifier unit 6082, and ail other units inside the intelligent unit 6080 to create new 3D stereo sound effects and outputs. In that case, the intelligent 3D earphone 6000 is to become a user's electronic ears to react and hear real world stereo sound effects and outputs, virtual world stereo sound effects and outputs, or a mixture of both.

A user's movements can be body movements or mind movements, visual movements, or sound movements, and can run separately or combined together in multiple ways. The user's mind movements or visual movements can be sensed by the brain sensor unit 6080M or eye/eyeball/iris/pupil/visual sensor unit 6080V with any electronic sensor devices to obtain the user's mind or visual electronic or nervous flows for mind work or eye/vision work or health work. For example, the electronic sensor devices could perform an electroencephalogram for brain cell or nervous electronic movements, could perform an electrocardiogram for heart beats, could be a blood pressure machine or temperature instruments, could perform visual or eye or eyeball or iris or pupil tracking, or could include sound or mouth tracking systems for VR/AR/MR effects and outputs, etc.

A user's surrounding environment or situation can be any kind of real world surround condition or situation around the user. The intelligent unit 6080 can sense a user's surrounding situation, such as light level, temperature, rain, wind, sky, sun, moon, stars, fog, physical things, human beings, animals, etc.

Thus, the intelligent 3D earphone 6000 can give environment signals to the user. For example, if the intelligent unit 6080 senses a stranger approaching, the intelligent unit 6080 immediately sends the warning signal to the earphone speakers 6018A/B/C for the user's safety check. If the intelligent unit 6080 senses a car trailing behind too closely, then the intelligent unit 6080 immediately sends the traffic warning signal to the earphone speakers 6018A/B/C for the user's alarm.

It is very important that the earphone has a safety alarm function to sense the user's situation safety, because all current earphones are with an “isolated function” for pure sound effects and outputs. Earphone Noise Isolation becomes a basic function for all earphones on the current market. A user wearing an “isolated” earphone has difficulty hearing outside sound, such as a traffic warning sound, etc. The intelligent 3D earphone 6000 can overcome that problem with its intelligent unit 6080 and its sensor/processor units 6080A/B/C to detect, process, analyze, and configure new 3D stereo sound effects and outputs to generate a safety warning function, such as for detecting and warning of a traffic red light, or sensing and warning an approaching car, etc.

At the same time, if needed, the intelligent unit 6080 can have a self-adjustable function according to a user's surrounding situation if needed. For example, if the intelligent unit 6080 and its sensor units 6080A/B/C sense that the environment becomes too noisy, the intelligent unit immediately self-adjusts the sound output volume level upwards based on the mode preset or preselected. If the intelligent unit 6080 senses the environment becoming quiet, the intelligent unit 6080 will auto-adjust back to the original 3sound output volume.

The intelligent unit 6080 can sense and control and auto adjust all noises from outside the earphone 6000 and all noises from inside the earphone 6000 such as electrical flow noise, etc., based on a user's needs, at the same time.

Also at the same time, the intelligent unit 6080 can have a coordination system to work with VR/AR/MR/AI visual and audio effects and outputs accordingly.

The intelligent 3D earphone 6080 contains the intelligent unit/sensor and processor units 6080/6080A/B/C inside and works with a detachable 3D vision tool 7000 together or individually or separately.

Therefore, a user's whole body movements are sensed by the intelligent unit 6080. The intelligent unit 6080 configures those sensed movements into new 3D stereo sound effects and outputs with the 3D vision tool 7000 together.

The 3D vision unit 7000 can be any kind of 2D or 3D vision device, such as for one eye like Google Glass, or for both eyes like Virtual Glass, or any VR/AR/MR devices, etc.

The 3D vision unit 7000, 3D earphone 6000, and the earphone player 8000 can work together for virtual visions (virtual reality functions), intelligent 3D stereo sound effects and outputs, and all intelligent cellular phone multiple functions In parallel synchronously, simultaneously, and collaterally.

Furthermore, the intelligent 3D earphone 6000 and intelligent unit 6080 and its sensors 6080A/B/C can work with any kind of earphone player 8000. For example, earphone player 8000 can be any kind of electronic device, such as, a cellular phone, a multiple player, a portable player, a computer, a notebook, a TV set, the internet, an app, an electronic portable device, a VR/AR/MR device, etc. The intelligent unit 6080 can send or command its electronic signals to any kind of earphone player 8000 by wireless or cable communication. At the same time, any kind of earphone player 8000 can send or command its electronic signals to the intelligent unit 6080 synchronously, by wireless or cable communication.

The earphone player 8000 can be any kind of multiple players, cellular phones, smart phones, electronic portable devices, laptops, notebooks, PC, app, VR/AR/MR/AI devices, etc., in various designs, materials, methods, functions, systems, materials, and formats, etc.

The earphone player 8000 may contain its own intelligent unit 8080 and sensor/processor units 8080A/B/C, very similar to the intelligent 3D earphone's intelligent unit 6080 and sensor/processor units 6080A/B/C. Those 2 sets of the intelligent units of the earphone player 8000 and 3D earphone 6000 work together to create new 3D stereo sound effects and outputs in parallel synchronously, simultaneously and collaterally, in one way, two ways, or multiple ways, with one direction, two directions, or multiple directions if needed.

The earphone player 8000 can send or receive the electronic signals to or from the intelligent 3D earphone 6000 and save those signals into electronic files or data. for replay, editing, saving, or delivery of intelligent 3D stereo sound usages anytime or anywhere, by wireless or cable communication.

The intelligent 3D earphone 6000 can send or receive the electronics signals to or from the earphone player 8000 and save those signals into electronic files or data, for replay, editing, saving, or delivery of intelligent 3D stereo sound usages anytime or anywhere, by wireless or cable communication.

Therefore, the intelligent 3D earphone 6000 can co-work with any kind of earphone player 8000 together at the same time. The intelligent 3D earphone 6000 and any kind of earphone player 8000 can exchange or co-work or co-do self-configuration of all kinds of data or files anytime or anywhere, by wireless or cable line communication.

The intelligent 3D earphone 6000 and its intelligent unit 6080 have to set up a beginning point first. The beginning point is called the Z point mode. There are an X axis and a Y axis for a traditional sound curve development. There is a Z axis for 3D stereo sound space development for X-Y-Z 3D stereo sound space. The Z axis is a key to create X-Y-Z 3 dimensional (3D) stereo sound. The beginning Z point is a key to create the intelligent 3D stereo sound system.

There are 3 kinds of Z points of the intelligent 3D stereo sound system in the intelligent 3D earphone 6000 and its intelligent unit 6080 and sensor units 6080A/B/C. First, is a user's self-standing point as the Z point A. This Z-self point mode is to use a user's position and self-movement for creation of the intelligent 3D stereo sound effects and outputs. Second, is a user's environment or surrounding as the Z point B. This Z-surrounding point is to use a user's surrounding and related environment for creation of the intelligent 3D stereo sound effects and outputs. Third, is a sound Z axis position and direction as the Z point C. This Z-axis sound point is to use 3D stereo sound depth (Z-axis) for creation of the intelligent X-Y-Z 3D stereo sound effects and outputs. Preferably, the Z-axis sound point is for the intelligent unit 6080 to control and manage and configure the speaker 6018B or any bass sound speaker to have the sound depth at a Z-axis sound space to achieve the intelligent X-Y-Z 3D stereo sound effects and outputs. Of course, the Z-axis sound point function can be used for any speaker 6018A or 6018D or for more speakers, or for any combination of those speakers 6018A/B, such as one, two, or three, or more, for the sound depth at a Z-axis sound space.

In general, the intelligent 3D stereo sound system containing those Z points A/B/C works with the intelligent unit 6080 together to control and manage and automatically configure the intelligent sensor units 6080A/B/C and speakers 6018A/S and sound effect unit 6032 and sound resonance unit 6036 to have the sound X-Y axis width and sound Z axis depth at a stereo sound space to achieve the intelligent X-Y-Z 3D stereo sound effects and outputs by following and reflecting a user's movements, environments, situations, and needs, synchronously, simultaneously and collaterally, as is more detailed in FIGS. 3 to 4B.

There are many sense modes of the intelligent 3D earphone 6000 and its intelligent unit 6080 and intelligent sensor units 6080A/B/C, such as for an accelerometer sensor, a magnetic field sensor, an orientation sensor, a gyroscope sensor, a light sensor, a pressure sensor, a temperature sensor, a proximity sensor, a gravity sensor, a linear acceleration sensor, a rotation sensor, a car sensor, an outside noise sensor, an inside noise sensor, a direction sensor, a navigation sensor, an orientation sensor, a balance sensor, a distance sensor, a visual/eye tracking or control sensor, a sound/mouth tracking or control sensor, for working in an Android system or an Apple system, or a window system, or other systems, etc., for real world or virtual world 3D stereo sound effects and outputs.

There are many function modes of the intelligent 3D earphone 6000, such as an intelligent 3D stereo sound mode, a mimic mode, a safety mode, a drive mode, an electronic control mode, a voice control mode, a display mode, a sport mode, a work node, a health mode, an intelligent 3D stereo sound and virtual mode, a VR/AR/MR mode, a drive mode, a game mode, etc.

There are many play modes of the intelligent 3D earphone 6000, such as a multiple player mode, a game mode, a sport mode, an education mode, a health mode, a security entertainment mode, a VR/AR/MR play mode, etc.

Of course, FIG. 6 also shows that the intelligent 3D earphone 6000 contains the intelligent unit 6080 and multiple speakers 6018A/B to deliver intelligent 3D stereo sound effects and outputs.

The Intelligent 3D earphone 6000 and its intelligent unit 6080 detect, analyze, process, and configure a user's motion movements and environments or VR/AR/MR requirements into 3D stereo sound frequencies and effects and outputs of the speakers 6018A/B at the best intelligent calculation and direction. Preferably, one speaker 6018A is a sound driver handling high frequency mostly. Another speaker 6018B handles bass and middle frequency range of sound mostly.

The speaker units 6108A/B can be one speakers, two speakers, three speakers, or multiple speakers, with any kind of design, position, location, structure, system, method, function, etc., such as positioned se in the same direction, opposite direction, to face each other, to be off-centered, to have a front-and-back arrangement at the same axis or a different axis, an up-down arrangement, a circle arrangement, a parallel arrangement, at the same angles, at different angles, inside or outside the earphone 6000, etc.

The intelligent 3D unit 6080 containing sensor units 6080A/B/C receives all of a user's movements and sound signals from the original sound tracks, or VR/AR/MR requirements, and additionally or mixed therewith the sensed user's movements or needs, and then analyzes, processes, and directs those original sound tracks or frequencies alone or mixed with the sensed and configured user's movements and VR/AR/MR needs into different sound channels and frequencies for those three speakers 6018A and 6018B working with the sound affect structure unit 6032 and sound resonance unit 6036 to create new intelligent 3D stereo sound effects and outputs following and/or reflecting the user's movements and surrounding environment situations and VR/AR/MR needs.

Inside the speaker cup unit 6006 there is a sound effect/check member or piece 6032 and other sound check members or pieces to create a 3D stereo sound resonance area 6036 within the ear cup unit 6006.

The cup unit 6006, speakers 6018A/B, sound effect unit 6032, and sound resonance unit 6036 can be any kind of shape or design with any kind of material, structure, function, method, system, and format, if needed.

The intelligent 3D earphone 6000 and its intelligent unit 6080 intelligently configure high frequency into the front speaker 6018A and bass/middle frequencies into the back speaker 6018B synchronously. Of course, there are many possible ways of 3D stereo sound configuration for achieving better sound stereo effects and outputs with minimized digital sound loss or distortion. For example, the intelligent unit 6080 may configure bass frequency into the front speaker 601BA and high/middle frequencies into the back speaker 6018B synchronously.

In this embodiment, there are two speakers (sound drivers) 6018A and 6018B inside the ear cup 6006. In order to arrange these two speakers (double sound drivers) in a front-and-back straight array or in an angled structure, one speaker 6018A is located at the front of the ear cup 6006 to handle high frequency. The second speaker 6018B is located at the back of the ear cup 6006 to handle bass/middle frequency of 3D stereo sound generated or configured from the intelligent unit 6080 with sensing and reacting to a user's movements and surrounding situations and VR/AR/MR/AI requirements.

Therefore, the two speakers 6018A and 6018B in a straight arrangement create a stage-like real sound delivery system in X-Y-Z three-dimensional (3D) sound stereo space because the two speakers 6018A and 6018B explore stereo sounds in two dimensions (X-Y axes senses) in a wide horizontal way. Plus, at the same time, the large speaker 6018B delivers very strong sounds, preferably in the bass frequency, from the back to have a Z-Axis stereo sound in a deep vertical way for X-Y-Z 3D stereo surrounding sound effects with bass/mid/high sound frequencies.

Generally speaking, the intelligent unit 6080 and its sensor units 6080A/B/C and speaker units 6016A/B have the following functions and work flows and systems of sensing, analyzing, and configuring at best value, synchronously and collaterally, as follows:

First, sensing or detecting a user's movements or surrounding environments or situations or needs with certain sense mode selected by the user, such as a VR/AR/MR/AI mode, etc.;

Second, receiving or performing original sound tracks and frequencies of X-Y-Z 3D stereo sound working in the sound effect structure 6032 and sound resonant unit 6036;

Third, analyzing, processing, and configuring the first point and second point together with a computerized best value calculation system and program to generate new X-X-Z 3D stereo sound effects and outputs for teal, world or virtual world of VR/AR/MR/AI, or a mixture of both;

Fourth, intelligently directing the new X-Y-Z 3D stereo sound channels and frequencies into different speakers 6018A/B/C working with the sound effect structure 6032 and sound resonant unit 6036;

Fifth, delivering the new X-Y-Z 3D stereo sound effects and outputs into a user's ears to satisfy the user's needs for X-Y-Z 3D stereo sound real-situation or real-stage enjoyments, or VR/AR/MR/AI, or a mixture of some of them or all of them, or all other needs if possible.

Of course, those steps can be adjustable or rotatable or interchangeable any time and anywhere it needed. For example, the second one can become the first one and first one can become the second one, etc.

There are many possible sound frequency and driver position combinations for those two speakers 6018A/B having a straight arrangement at the front and the back or at a parallel side structure, or mixed positions, or angled positions, in the same direction or in a different direction or in an opposite direction, to face each other, inside of the ear cup 6006 or earphone 6000, as detailed in U.S. Pat. No. 7,697,709 and No. 6,515,103.

The intelligent 3D earphone 6000 may contain 2 speakers 6018A and 6018B, or 3 speakers or 4 speakers or more speakers with different positions and structures, designs, methods, systems, materials, formats, and sizes if needed.

There can be just one speaker 6018A designed and arranged inside the intelligent 3D earphone 6000 as shown for example in the embodiment of FIG. 6B.

All units may vary in design, shape, structure, system, method, function, and material if needed to apply into the various embodiments of earphones shown in FIGS. 1 to 7.

All units and functions and structures explained above and shown in FIGS. 1 to 7 may be used, applied, or inter-exchanged in any figure of this application for all types of earphones and headphones if needed.

FIG. 6C shows one embodiment of the intelligent 3D earphone 6000 to have an On-Ear cup design with a flat sound output unit 6020. The flat sound output unit 6020 is preferably to use soft sponge material inside and soft smooth surface material outside to obtain a comfortable ear touch feeling and to be tight enough for sound delivery into a user's ear.

The design, material, format, structure, system, and method of the sound output unit 6020 may vary if needed.

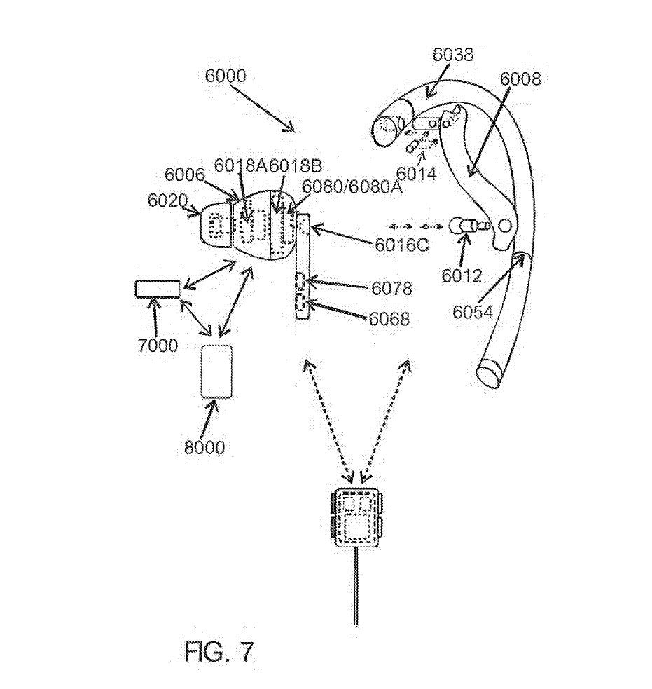

FIGS. 6C and 7 show another embodiment in which the intelligent 3D earphone 6000 works with a detachable ear band 6038 through the unit 6016C and unit 6012 working together, in a cable or wireless manner.

Because the present improvement was simultaneously researched and developed together with the inventions of the Sound Direction/Stereo 3D Adjustable Earphone of U.S. Pat. No. 7,697,709 and 3D Stereo Earphone with Multiple Speakers of U.S. Pat. No. 8,515,103 under 3D Earphone Whole Concept, the unit 6016C of the intelligent 3D earphone 6000 may work with the detachable speaker cup holding unit 6008 through the ball/male unit 6012 for attachment or detachment functions and structures. The unit 6008 works with the ear band unit 6038 through the attachment and detachment unit 6014. With the attachable/detachable unit 6016C, the speaker cup unit 6006 may work with the sound 3D adjustable direction speaker cup holding unit and ear band unit 6008/6038 to independently achieve holding and adjusting functions for hearing comfort, hearing safety, wearing comfort, and wearing stability, for example so that the earphone 6000 may be worn for sports.

The intelligent 3D earphone 6000 may have a cable or wireless function unit 6078 and a microphone unit 6068. The wireless unit 6078 can wirelessly connect the intelligent 3D earphone 6000, the earphone player 8000, and the 3D vision unit 7000 all together at the same time. The wireless unit 6078 and microphone unit 6068 may have different designs, structures, systems, methods, formats, functions, etc.

The attachment/detachment socket/female joint unit 6016C and the ball/male unit 6012 may be reversed so that the ball/male unit is on the back side of the cup unit 6006 and the socket/female joint unit is with the holding unit 6008.

The design, function, size, shape, location, method, and material of the units 6016C and 6012 and joint unit 6014 may vary. For example, the units 6016C and 6012 may work together through a C clip structure or with a method for attachable and detachable functions.

All Joint units 6016C and 6012 and 6014 may be designed to be attachable and detachable as a big C structure, or clip structure, or as a plug in-and-out structure, or as a ball structure, or a stick structure, or a bar structure, or any kind of attachable and detachable fastener structure.

Another joint part 6054 on the ear band 6038 adds joint movement function and structure. The ear band 6038 can be adjusted or bended at the joint part 6054 to follow a user's ear shape for wearing comfort and stability. Joint part/unit 6054 can be any kind of joint part, structure, method or material and can be any size.

The earband 6038 can be unbendable or bendable with kind of material, structure, method, design, function, system, etc.

All intelligent units and sensor/processor units in FIGS. 1 to 7 can be designed or structured or systemized or organized with any location or position or arrangement inside or outside the intelligent 3D earphones 5000 and 6000, and earphone player unit 8000 and vision player vision 7000, with one unit or with multiple units together, separate, or independent, or mixed, with a cable connection or a wireless connection. The intelligent units and sensor/processor units can be designed, structured, systemized, or organized with any location or position or arrangement inside or outside the intelligent 3D earphones 5000 and 6000, and earphone player unit 8000 and vision player vision 7000, to work together synchronously, simultaneously, and collaterally.

All units may vary in design, shape, structure, system, method, function, and material if needed to apply into the various embodiments of earphones shown in FIGS. 1 to 7.

All units and functions and structures explained above and shown in FIGS. 1 to 7 may be used, applied, or inter-exchanged in any figure of this application for all types of earphones and headphones if needed.

What is claimed is:

1. An earphone producing an intelligently-changing stereo sound effect, the earphone comprising:
(a) an ear cup;
(b) at least one speaker disposed in said ear cup;
(c) a processing unit disposed in on attached to said ear cup and connected to said at least one speaker; and
d) at least one sensor disposed in or attached to said ear cup and connected to said processing unit;
wherein said at least one sensor is configured to sense a movement of the earphone or an environmental change of the earphone and to send the processing unit a signal representing the movement or the environmental change;
wherein said processing unit is programmed to process the signal and to generate a changed stereo signal for the at least one speaker, the changed stereo signal being changed according to the movement or the environmental change; and
wherein said at least one speaker is configured to receive the changed stereo signal and to generate a changed stereo sound effect according to the changed stereo signal.

2. The earphone according to claim 1, wherein the processing unit and the at least one sensor are part of a modular assembly configured to be attachable to and detachable from the ear cup.

3. The earphone according to claim 1, wherein the processing unit is separate and independent from the at least one sensor

4. The earphone according to claim 1, further comprising an input/output unit, the input/output unit being configured to display at least one function icon and to allow a user to input a function via the at least one function icon for controlling operation of the processing unit.

5. The earphone according to claim 4, wherein the input/output unit is configured to be attachable to and detachable from the ear cup; and
wherein the processing unit and the at least one sensor are part of the input/output unit.

6. The earphone according to claim 1, wherein the earphone is a member selected from the group consisting of an in-ear earphone, an on-ear earphone, an around-ear earphone, and an over-ear earphone.

7. The earphone according to claim 1, wherein the at least one speaker comprises a plurality of speakers;
wherein the at least one sensor comprises a plurality of sensors configured to sense a movement of the earphone or an environmental change of the earphone and to send the processing unit a respective signal representing the movement or the environmental change; and
wherein said processing unit is programmed to process each signal from the plurality of sensors to generate a changed stereo signal for the at least one speaker, the changed stereo signal being changed according to the movement or the environmental change.

8. The earphone according to claim 7, wherein said at least one speaker comprises a first speaker, a second speaker, and a third speaker;
wherein the processing unit is configured to send a high sound frequency signal to the first speaker, to send a middle sound frequency signal to the second speaker and to send a bass sound frequency signal to the third speaker; and
wherein each of the high sound frequency signal, the middle sound frequency signal, and the bass sound frequency signal is changed by the processing unit according to the movement or the environmental change sensed by the plurality of sensors.

9. The earphone according to claim 1, wherein said at least one sensor is selected from the group consisting of an accelerometer sensor, a magnetic field sensor, an orientation sensor, a gyroscope sensor, a light sensor, a pressure sensor, a temperature sensor, a proximity sensor, a gravity sensor, a linear acceleration sensor, a rotation sensor, a car sensor, an electrical signal sensor, a wireless signal sensor, a sound sensor, a heart sensor, a blood pressure sensor, a small sensor, a space sensor, an environment or surrounding sensor, a traffic sensor, a warning sensor, a motion sensor, an outside noise sensor, an inside noise sensor, a direction sensor, a navigation sensor, a balance sensor, a distance sensor, a visual/eye tracking or control sensor, a sound/mouth tracking or control sensor, and a brain sensor.

10. A headset producing an intelligently-changing stereo sound effect, the headset comprising a first earphone according to claim 1 and a second earphone according to claim 1, wherein the first earphone is a left earphone and the second earphone is a right earphone.

11. The headset according to claim 10, further comprising an adjustable headband unit connecting the left earphone and the right earphone.

12. The headset according to claim 11, further comprising a microphone connected to at least one of the left earphone and the right earphone.

13. An earphone system for producing an intelligently-changing stereo sound effect, the earphone system comprising;
at least one first earphone according to claim 1; and
at least one first control device configured to communicate with the processing unit wirelessly or via a cable connection;
wherein the at least one first control device and the at least one first earphone work together to cause a changed stereo sound effect produced by the at least one speaker, the at least one speaker producing the changed stereo sound effect based on a changed stereo signal from the processing unit, the changed stereo signal being produced by the at least one sensor and by the at least one first control device according, to a movement of the earphone or an environmental change in an environment of the earphone.

14. The earphone system according to claim 13, wherein the at least one first control unit is selected from the group consisting of a cellular phone, a multiple player, a portable player, a computer, a notebook, a TV set, an electronic portable device, a VR device, an AR device, an MR device, art AI device, a 3D holography device, a robot, an internet communication system, a satellite communication system, and a GPS system.

15. An earphone system for producing an intelligently-changing stereo sound effect, the earphone system comprising:
at least one first earphone according to claim 1; and
a vision unit connected to the at least one first earphone;
wherein the at least one first control device and the vision unit operate in conjunction to provide synchronized virtual reality visual and audio signals changed according to movement of the at least one earphone and the vision unit or to environmental changes for the at least one earphone and the vision unit when a user of the kit wears the at least one first earphone and the vision unit; and
wherein the vision unit is a two-dimensional vision unit, a three-dimensional vision unit, or a two-dimensional and a three-dimensional vision unit.

16. The earphone system according to claim 15, further comprising a microphone connected to the at least one earphone.

17. An earphone system for producing an intelligently-changing stereo sound effect, the earphone system comprising:
at least one first earphone according to claim 1; and
a plurality of external sensor and processing units configured to communicate with the processing unit of the at least one first earphone, the plurality of external sensor and processing units being configured to be attached or detached to various portions of a body of a user of the at least one first earphone;
wherein the at least one first earphone and the plurality of external sensor and processing units work together to cause a changed stereo sound produced by the at least one speaker, the at least one speaker producing the changed stereo sound based on a changed stereo signal from the processing unit of the at least one first earphone, the changed stereo signal being produced by the at least one sensor and by the plurality of external sensor and processing units according to a movement of the earphone and the plurality of external sensor and processing units or an environmental change in an environment of the earphone and the plurality of external sensor and processing units.

18. The earphone system according to claim 17, farther comprising a plurality of fasteners, each fastener of the plurality of fasteners being connected to a respective external sensor and processing unit of the plurality of external sensor and processing units, each fastener being configured to attach the respective external sensor and processing unit to the body of the user.

19. The earphone system according to claim 17, wherein a first external sensor of the plurality of external sensor or processing units comprises a member selected from the group consisting of an electrocardiogram sensor, a hand sensor, a foot sensor, a body sensor, an instrument sensor, and a game sensor.

20. The earphone system according to claim 17, wherein a first external sensor and processing unit of the plurality of external sensor and processing units comprises an input/output unit configured to display at least one function icon and to allow a user to input a function via the at least one function icon for controlling operation of a processing unit of the first external sensor and processing unit; and
wherein the input/output unit is configured to be attachable to and detachable from the first external sensor and processing unit.
